(19) United States
(12) Patent Application Publication
(10) Pub. No.: US 2014/0066191 A1
(43) Pub. Date: Mar. 6, 2014

(54) METHOD AND SYSTEM FOR ACTIVATING NON-CORE FEATURES BY EXTERNAL USERS IN AN ASYNCHRONOUS GAME

(71) Applicant: Grant Chieh-Hsiang Yang, Fairview, TX (US)

(72) Inventor: Grant Chieh-Hsiang Yang, Fairview, TX (US)

(21) Appl. No.: 13/598,410

(22) Filed: Aug. 29, 2012

(51) Int. Cl. A63F 13/00

(52) U.S. Cl. 463/29

(57) ABSTRACT

A method and system for external users to activate non-core features in a game. Users activating features in an opponent's turn in an asynchronous, turn-based, player vs. player game are activating non-core features. Users may also activate non-core features in matches of a game that they are not a part of through a leaderboard. Leaderboards may be presented in various ways, including by score, rating, round, etc. and players may be directly challenged on the leaderboards.

There are many types of video games, these can include sports, actions, fighting, first-person shooters (FPS), etc. There are single player games, which are games played by a single player, and there are multiplayer games, those played by more than one player. Multiplayer games can include player versus player (PvP) games, team versus team, or player versus team, or a combination if there are multiple teams. An example of a player versus player game is chess or “singles” tennis, where there are two players in a closed game and there are no other participants in the game. However, a PvP game can also vary in terms of the number of players playing against each other. For example, in typical synchronous FPS games, there is a “deathmatch” mode wherein each player is playing against every other player. This is typically known as a multiplayer free-for-all game. Multiplayer may thus be either competitive, cooperative (otherwise known as co-op), or a combination of both, wherein players that are teams are cooperatively competing against another team, either against real live players, computer artificial intelligence (AI), or a combination of both. For example, in a combination a player may control or direct computer players on how to behave.

When users or players (terms which may be used interchangeably herein to describe a person playing a game), are playing a game, they are typically motivated by competition. Otherwise, if users are playing by themselves they are less engaged and have lower retention, in other words, they come back to play the game less often. Users also like to be social and to compete with their friends. Problematically, most real life players cannot play together in real life time because they are playing games on different schedules. Most single player games try and solve this problem with leaderboards. A leaderboard is a ranking system wherein users are ranked by a pre-determined metric of the game. For example, a “high score” may be a method of ranking players. Another method may be a user's win/loss record, or simply a win record. However, in such instances, players are not playing necessarily competitively with each other, rather they are playing against a computer AI, or some other kind of pre-defined or predictive environment. Users would want to activate core features, that is activities that are part of the main gameplay; however, this would be difficult without being synchronous. Users would also want to activate non-core features, those features that are not critical to the gameplay, such as powerups, special attacks, etc.

### BRIEF DESCRIPTION OF THE DRAWINGS

FIG. 1a illustrates a schematic of an example configuration of an asynchronous game with multi and cross-platform capabilities as well as having the ability to activate non-core features in games by external users, wherein data is processed through a network and client-server communication.

FIG. 1b illustrates a schematic of an example configuration of an asynchronous game with multi and cross-platform capabilities as well as having the ability to activate non-core features in games by external users, wherein data is processed through network communication on the client terminals.

FIG. 2a illustrates and example of a game that could be played in an asynchronous manner.

FIG. 2b illustrates an example of how a non-core feature, such as powerups, may apply in the game.

FIG. 2c illustrates how, building off the examples of FIGS. 2a and 2b, the powerup menu containing non-core features to the gameplay may appear to a user.

FIG. 2d illustrates, building off the examples of FIGS. 2a through 2c, the powerup non-core feature is active and displayed in a player's screen.

FIG. 2e illustrates, building off the examples of FIGS. 2a through 2d, a powerup non-core feature that is activated by the opponent and displayed in the second player's screen to counteract the non-core feature activated by a first player.

FIG. 3a depicts an example process flow of how non-core features may be activated by an external user.

FIG. 3b depicts an example process flow of the determination of non-core features to activate and the activation of those figures, or an example of a more detailed process flow of the example processes of 3010 and 3011 of FIG. 3a.

FIG. 4a illustrates an example of a game that could be played in an asynchronous manner as a team.

FIG. 4b illustrates an example of the gameplay that could be played in an asynchronous manner as a team with a non-core feature activated.

FIG. 4c illustrates an example of the memory targeting system in game that could be played in an asynchronous manner as a team, building off the example from FIGS. 4a and 4b.

FIG. 4d illustrates an example of the screen for a user to activate a non-core feature after the end of their turn.

FIG. 4e illustrates an example of the memory targeting system as used in the flight game that could be played in an asynchronous manner as a team, and shown how an external user activates a non-core feature.

FIG. 4f1 shows an example leaderboard.

FIG. 4f2, showing the same leaderboard from FIG. 4f1, further explains that each ranking spot contains a first player on the team and a second player on the team.

FIG. 4f3 shows the same example leaderboard from FIGS. 4f1 to 4f2.

FIG. 5 depicts an example process flow of how a leaderboard and its associated features may be used by a user.

FIG. 6 illustrates an alternative style of leaderboard, where users are ranked by their personal rating rather than metric, such as a score, of the game.

FIG. 7 illustrates the process flow of a system that accounts for a new entrant into a system to properly create an initial rating of the user.

### DETAILED DESCRIPTION

In order to create a faux-social environment, external users to a game may want to activate non-core features in an asynchronous (“async”) game, in particular non-core features that are not a part of that external user's move. However, even this has the problem of how to transmit the activation of the non-core features. Even if this issue was resolved, on networked games, not all users of a game may have the same non-core features available to be activated. For example, core features may be those that are the minimum viable features of the gameplay that would be required to be programmed into the source code of a game. However, non-core features may be additional features that are added on over time. Some users may update their code and have the most recent version of the game, and thus all the available assets to have a non-core feature activated (e.g. the source code, the art images, the sound assets, etc.). However, other users may only have the version of the game that is needed to simply run the minimum viable gameplay, and therefore, they have not downloaded art or sounds that should be viewable or heard should those non-core features be activated by another user. For example, if there is a video game where the core feature is tennis, the core feature that a user makes on their turn is to hit the ball on their turn. If a non-core feature attack by a second user were to, for example, blind the first user by partially blocking the view of the screen, and if that functionality was not available through code, then the first user would not actually be able to display the attack of the non-core feature initiated by the second user.

A user may also want to be allowed to activate a non-core features against users in which they are not a participant in a game. For example, a first user may view a second user on a leaderboard. The first user may be lower in rank than the second user on the leaderboard and would thus be compelled to want to beat that second user. However, the only non-social and non-interactive method of affecting the second user in leaderboards is to simply either directly or indirectly challenge the user, either to a one-on-one match (if the leaderboard is based on elimination) or by playing the game and hoping to get a higher score (if the leaderboard is based on a different factor such as high score achieved during the game). Or, in the instance of a single player game, there is no way for a second user to affect a first user at all except for the second user to play the game by himself. This limits the appeal of the leaderboard because the two users are not able to actively affect each other, and thus, are playing by themselves and not in a “social” or truly interactive manner.

Example embodiments of the invention include systems and methods for activating non-core features by external users in an asynchronous game. A core feature is a feature that is part of the main gameplay or the minimum features necessary to play the game. For example, in a synchronous FPS game, the core feature of the game is movement, shooting weapons, changing weapons, etc. A non-core feature may be items that are not essential to the basic mechanics of the game, such as powerups. For example, an invincibility shield that is earned through points, or bought in the game with either real world money or game currency, may be non-essential and, therefore, a non-core feature. As another example, having a weapon or defense in-and-of-itself is still a core feature, as you would be unable to play an FPS without being able to shoot. However, having a special weapon, such as calling in a special airstrike, may be a non-core feature.

Another example of a core feature is in an asynchronous board game, the core features of the game may be actually solving the puzzle, where a non-core feature may be the user buying an in-game “hint”. A purchased advantage may be a non-core feature, particularly if it is not part of the gameplay and it is implemented by one user to be applied in a second user's turn of an asynchronous game. Of course, non-core features need not always be purchased, as there may be instances where a non-core feature is awarded as part of a gating situation, for example, leveling up a character or avatar, passing a certain level, defeating a specific opponent, defeating a certain number of opponents, defeating opponents of a certain level, or playing a specific number of games, picking up the powerup through gameplay, etc.

The example embodiments describe activating non-core features in an asynchronous game, rather than in a synchronous game. A synchronous game is one that happens in “real-time” or is at least simulated in “real-time,” that is things are happening in the same moment for the players in the closed game environment. For example, two players could be playing a multiplayer online tennis game synchronously. One player may “pause” the game to temporarily stop the game. In real-time nothing is happening but in game time the game clock stops for both players, hence it is a simulated synchronous game. This is compared to real life, where a player cannot “stop” the game in real-time. That is, a player may call “timeout” but if a player called timeout in the middle of a point, all movement would not stop.

Synchronicity is not meant to be dependent on the attainment of a win as part of a game loop. An invest and express game, for example, would not be a synchronous game, but considered to be an asynchronous game, despite the fact that there are “gating” features that may cause one user's forward progression to be dependent on other users' actions. A synchronous game happens with the simultaneous presence of more than one player (whether real or artificial intelligence (AI)).

A “gating” feature is a game design technique that limits a player's progress in the game until a specific task or objective is completed by that user. One example could be limiting a user's access to a powerup in a game or limiting the number of techniques or weapons a player can use. Another example could be limiting the user from reaching a level in the game. Another example could be physically limiting a player's avatar from entering a location in the virtual world of the game environment. Another example may be to limit virtual features, such as to limit the ability to attain certain levels or certain levels in a skill tree or to assign skill points. In co-op games, such as those with another real-world player or an ally that is controlled by a computer AI, there can be synchronization gating, wherein a player cannot move forward until the other player or players have reached a specific point or completed a specific task.

Gating is contrasted with a user taking a turn in a turn-based asynchronous game. In such a game, players move at different times and a player has to wait for a player to complete their move or turn before they can make their turn. Gating is a technique used to prevent a player's progress until a condition has occurred; whereas, even though taking a turn is conditioned on waiting for another player's move, a turn in a turn-based game is an exception to this definition of gating. Hereinafter, the terms move, turn, round, action, etc. may be used interchangeably to refer to the encapsulation of all the activities that a first player must complete before a second user to make his move, turn, etc.

Asynchronous games are those where the players do not have to be playing in the same real world temporal time. This type of game lends well to turn-based games because the actions of a first player during the first player's turn is not affected by the specific actions of a second player. For example, chess is a turn-based game because each player makes a move during their turn. A second player cannot make a move until a first player has completed their turn. Two players cannot move their players at the same time. Likewise, in another example, checkers is a turn-based game because a first player makes a move and then the next player takes his turn. The first player can take multiple actions in the move; nevertheless, each player takes their turn or makes their move, which may encapsulate the multiple actions in the move. Thus, in the checkers example, a player can make multiple “jumps” in a row, wherein each jump is a certain action, but the player's turn or move consists of those multiple jumps. After the player has completed that turn, then the next player can make their turn. A turn of a player may also consist of many phases, for example, in a turn-based tower defense game, a first user may have both a build phase where they build their own tower and an attack phase, where they attack an opponent's (the second user's) tower. The second user's turn may also be a build phase, where they build a tower and an attack phase where they attack the first player's tower. Though there are multiple phases in the turn, each user has a distinct turn in the game.

The distinction in asynchronous games being capable of being played not in real-time (e.g. not at the same time) is also important because of how the technology would need to be implemented. One of the issues with synchronous or real-time gameplay is the difficulty of latency or lag. For example, in the simple example with two real world players in an online FPS game, if a user is playing against another user (or even if a player is playing with another user against computer opponents) the actions of the users have to appear to each other to be synchronous. That way, if a first user shoots at, for example, another computer opponent, then the second user has to be able to view that on his screen so that he is also not spending resources (e.g. bullets) shooting that same computer opponent. Similarly, in another example, if two users are playing a racing game together the players need to know in real-time how the users are reacting. For example, if a first user moves ahead of the second user in the race, it needs to be shown to the second user how the first user moved in real-time in order for the second user to react.

In both “synchronous” examples, the networking data packets that are sent over the network may be sent in a parallel or serial fashion. For example, in the racing example, the incremental movement of the first user's car may be sent over an online data network to the second user to display to the second user the first user's car's movement. The second user's movement may then be sent back over an online data network to the first user to display the second user's car's movement. The back and forth action of the data packets, however, does not represent asynchronous play because the data networking, whether sent in parallel or serially, is meant to represent real-time movement, and a second user is not able to see all the activities of the first user in a complete loop or turn of a gameplay cycle.

On the other hand, in an asynchronous game, a second user has to wait for an entire cycle of the first user's gameplay loop before being able to make his own cycle in the gameplay loop. One may be confused by the technical nature of data transfer to mistake the incremental back and forth nature of that transfer to be asynchronous. However, the distinction is in the complete cycle of the gameplay loop, and this is typically signified by a goal, whether it is a movement (e.g. moving a chess piece or checker piece on a board), an action (e.g. placing a letter tile or a group of tiles to form a word on a word game), or a trade (e.g. making a player trade in a fantasy sports league), etc. The completion of the gameplay cycle should be definable. In a race, if a first player moves ahead of the second player, that is a state in the gameplay, but it does not define the end of the loop for the first player.

One example of defining a loop in the gameplay is, for example, to allow two players to race and define the loop as the entire race. Therefore, a first player can race his car on the track without seeing the second player's movements. The second player can race his car on the track also. The loop ends with the end of the race and both players' results are sent to each other.

Another way of implementing a race game in an asynchronous manner is to define the end of the game loop as the completion of a lap (assuming the start and finish in this example are in the same location). As per the example, a first player races one lap in a three lap race, and after the completion of the lap sends the “move” to the second player. In one version, the second player is racing against the first player's already completed move and the data is set, wherein the first player is allowed to affect the second player (e.g. by blocking the second player from passing), but the second player may not be able to affect the first player's move. In another version, the implementation may be done in a “ghost” manner, wherein the second player can see the “ghost” car of the first player but neither the first player or second player's car actually affect each other (e.g. the two cars cannot touch in the virtual world) and the second player's car moves through the first player's car, like that of a “ghost” if they are occupying the same space in the virtual world. In this instance, the “ghost” car simply exists as a metric for the second player to know his relationship in the race with the first player. Thereafter, on the second lap, the second player may go first to ensure that both players have had an opportunity to be able to get a metric of the other player in their turn. Therefore, as per the example, the first user may see the second user's ghost car. Then on the third and final lap, the game may not have a ghost car for either user, or may simply allow the user that is losing go second so that he has a chance to watch the first player's “ghost” car to have a chance of “catching up.”

Asynchronous games also have the advantage of not having to be played online and helps to explain the difference between real world versus non-real world synchronicity. An asynchronous game can be played offline on the same device on “pass and play” (PnP). PnP allows a first player to make a “move” and “pass” the device to a second player to make their “move.” Thus, in the example above, a synchronously played real-time game would be impossible to be played in PnP mode because a second user would be unable to see how a first user made their entire “move” or “loop” of gameplay, such as the entire lap, while the second player was making his own move.

An example embodiment may include a method or process for activating non-core features in an asynchronous game, comprising receiving a request to activate a non-core feature from a first user, wherein the input to activate the non-core feature is made on one or more computing devices, storing the activation of the non-core feature, and sending the request to activate the non-core feature to a second user, wherein the second user is participating in the closed game environment corresponding to a computer-implemented game. The method for activating non-core features in an asynchronous game, may further comprise receiving, by one or more computing devices, a move for a closed game environment corresponding to a computer-implemented game from the first user, storing the move from the first user in a storage device; and sending the move for the closed game to the second user.

In an example embodiment of activating non-core features in an asynchronous game, the non-core feature may be activated specifically for the subsequent turn of the second user. In other words, the non-core feature may be for the direct next turn, but it may also be for a later-specified turn, or may be saved for if it is needed. For example, in a team mode, to be described below, a non-core feature may be a revive powerup, where the non-core feature is only activated if the teammate died and needed to be revived. This non-core feature may not be activated until the teammate actually hit the death state. The example method may further comprise activating the non-core feature using stored data. As explained below, the data stored may be data related to information specific to the second user, such as their playing style or actual data related to how the second user responds to the specific non-core features or to general non-core features. Or, the data stored may be related to data among a subset of all users in the game, wherein a subset may be none, a portion, or all of the users playing the game, or even users using similar non-core features in other games. The data may also be pre-defined variables to the game.

Example embodiments of a method for activating non-core features in an asynchronous game may further comprise sending data to the second user to implement the non-core feature activation. The non-core feature may be customizable by the first user before activation. For example, a user may be able to send different levels of non-core features, such as a single attack, an attack dealing more damage, an attack having more frequency, etc. The severity of the attack may vary depending on the user's level or the amount of virtual money spent to upgrade the attack. Though upgradable a user may also choose not to upgrade the non-core feature. Moreover, a user may be able to combine non-core feature attacks into a more powerful attack. The move to the second user and the non-core feature may be separately sent or may be encapsulated in a move object that defines a sequence of events graphically illustrated on a computing device of the second user.

The activation of the non-core feature may be tied to the use of a virtual currency. However, a user may be able to apply attacks if the non-core feature is stored in a bank of accumulated non-core features that a user is able to call on anytime. The activation of the non-core feature may also be by a third user that is not a participant in the closed game environment, in other words a single match of a game, corresponding to the computer-implemented game, or the actual game that the players are in. The third user may activate the non-core feature from a leaderboard and when the turn is taken the results of the closed game may be further stored and updated on a leaderboard.

The example embodiment of the method for activating non-core features in an asynchronous game, may further comprise receiving a move from the second user, wherein the move contains the results affected by the first user's activation of the non-core feature. The method may further comprise receiving a request to activate a non-core feature from the second user to be activated in the next turn of the first user, in other words, two players in a turn-based game may activate non-core features in each others' subsequent turns.

An example embodiment may also be an apparatus, comprising one or more processors and a memory coupled to the processors comprising instructions executable by the processors, the processors operable when executing the instructions to, receive a request to activate a non-core feature from a first user, wherein the input to activate the non-core feature is made on one or more computing devices, store the activation of the non-core feature, and send the request to activate the non-core feature to a second user, wherein the second user is participating in the closed game environment corresponding to a computer-implemented game. The apparatus of may further comprise executing instructions to receive a move for a closed game environment corresponding to a computer-implemented game from the first user, store the move from the first user in a storage device, and send the move for the closed game to the second user.

An example embodiment may also be a non-transitory, computer readable medium comprising instructions operative, when executed, to cause one or more processors to receive a request to activate a non-core feature from a first user, wherein the input to activate the non-core feature is made on one or more computing devices, store the activation of the non-core feature, and send the request to activate the non-core feature to a second user, wherein the second user is participating in the closed game environment corresponding to a computer-implemented game. The non-transitory, computer readable medium may further comprise instructions operative, when executed, to cause one or more processors to receive a move for a closed game environment corresponding to a computer-implemented game from the first user, store the move from the first user in a storage device, and send the move for the closed game to the second user.

Detailed descriptions of the above example embodiments may be illustrated herein.

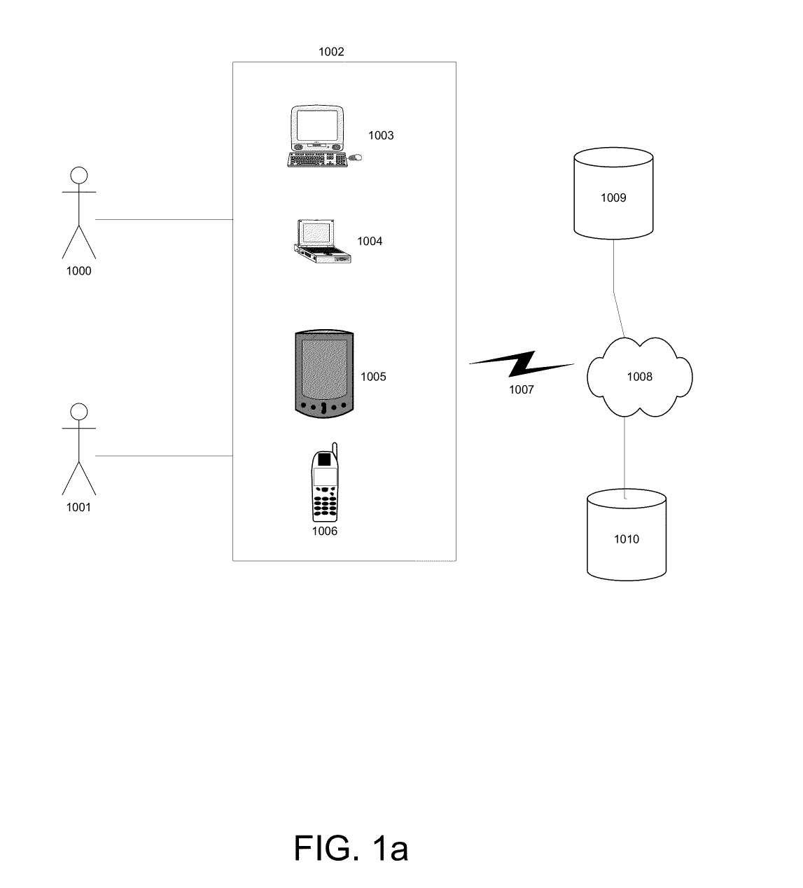

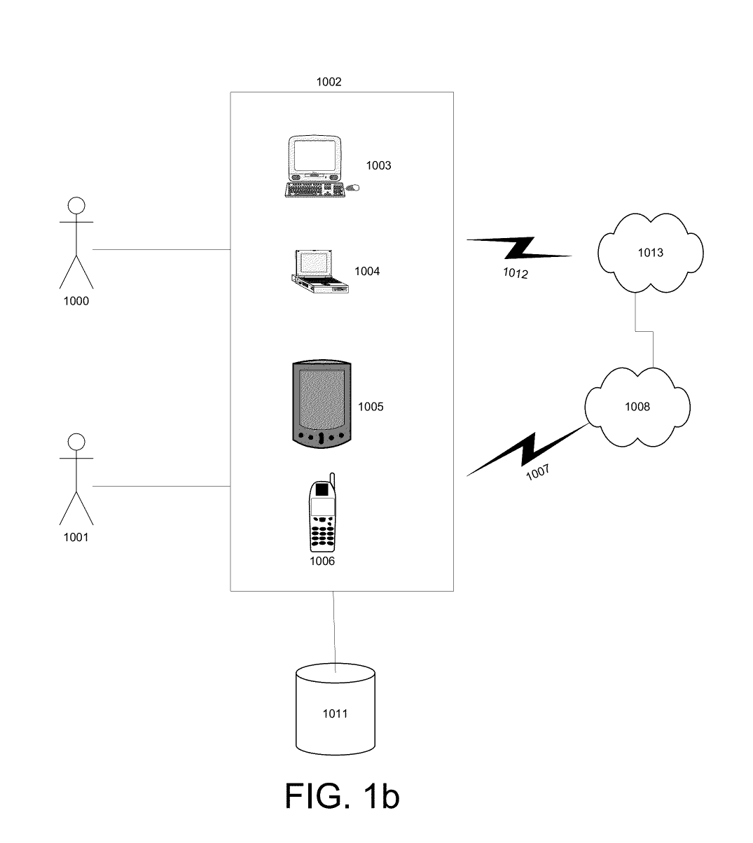

FIG. 1a illustrates a schematic of an example configuration of an asynchronous game with multi and cross-platform capabilities as well as having the ability to activate non-core features in games by external users, wherein data is processed through a network and client-server communication. The schematic depicts the data flow between the components of the system. Humans 1000 and 1001 (who may be users, players, etc.) may access client terminals 1002, which may be a larger client device like a desktop 1003 or laptop 1004 or may be a handheld device, such as a smartphone 1005, feature phone 1006, or any other number of client computing devices, such as a tablet, PDA, etc. that are not depicted. It is noted that the system is not limited to only two users, and there may be multiple client terminal 1002 configurations per user. The client terminals 1002 may be an interface such as a web application or a stand alone application on a smartphone or other client in any number of formats. The client terminals 1002 may interact through a communication link 1007 to a network 1008. The communication link 1007 may communicate over a network through any number of networks 1008, such as through servers or proxy servers, through the internet, through portions of a network, through an ad hoc network, an intranet or extranet, through firewalls, over a virtual private network (VPN), local area network (LAN), wireless LAN (WLAN), wide area network (WAN), wireless WAN (WWAN), through public or private networks, and the communication link may be over number of fiber, cable, satellite, DSL, wireless or other form of technology or communication, or a combination thereof. The network may in turn communicate with a game network module 1009 which may process and store game moves, including core and non-core features. The network 1008 may also connect to a leaderboard module 1010 which may process, store, and track rankings of users. The game network module 1009 and leaderboard module 1010 may be servers that contain the instructions to perform the processes of asynchronous game moves and ranking of users. The database of the modules may also store information and be able to retrieve the information and to send to different client terminals 1002 of the users 1000 & 1001.

In all instances of FIG. 1, anything that is completed over a network can be configured to be completed on the client, on the server, on a combination of both, or executed exclusively on one device and have the information passed and parsed on another device. Moreover, in all instances of the system in FIG. 1, any storage of information that is sent from a client may be processed and stored in a single module on a single database, or may be distributed across multiple servers. Moreover, the clients or servers or other computing devices may be arranged in any number of methods, including different types of mass storage, processors, cache, etc. The processing units may be any variation of processing technology, including but not limited to, central processing units (CPUs), graphic processing units (GPUs), etc. or other processing modules. The input/output (i/o) method may be across a high performance bus or any combination of i/o technologies and the client and server devices may run on any single or combination of operating systems, including but not limited to the Windows, LINUX, unix, Apple Macintosh, etc. The storage elements may be consist of any type of non-transitory storage media, including but not limited to, tapes, disks, dynamic random-access memory (DRAM), optical disc drives, volatile memory that may be later transferred to non-volatile memory components, optical memory storage, flash memory, etc. and in any type of configuration, such a single storage devices, redundant array of independent disks (RAID) configurations, cloud storage, etc. Moreover, the information may be processed on any type of server, regardless of the designated name (i.e. a “game” server may process game moves but may also process economy or purchase function calls or analytics calls, and vice versa).

FIG. 1b illustrates a schematic of an example configuration of an asynchronous game with multi and cross-platform capabilities as well as having the ability to activate non-core features in games by external users, wherein data is processed through network communication on the client terminals. For example, as in the previous example, there may be one or more users 1000 & 1001 that are playing an asynchronous game on a client terminal 1002 of various types of client device types 1003-1006. Data may be transported over communication links 1007 & 1012 through various networks or clouds 1008 & 1013. However, rather than have the data processed through a server or stored on a server, the data is directly stored and processed on the client device 1011. For example, an implementation may be a direct client to client Bluetooth connection and data is being passed directly between the devices. Variations of the different combinations of the data flow will be explained in later figures. There may be reasons why a user would want to go through a server versus only sending through client. For example, in a situation where an async game is meant to be played for a longer period of time, or even if changes to the application are made that accidentally break the application, a user may need to delete the game application from the client device. In such a situation, if all of the moves are not stored on the server, it may require that the client receive not only the updated move, but the entire game from the other user. There would need to be a process in place that a client may be able to request an entire game, rather than just receive the move. Otherwise, the normal communication would be for each client device only to update per new move and cache the data on the client device.

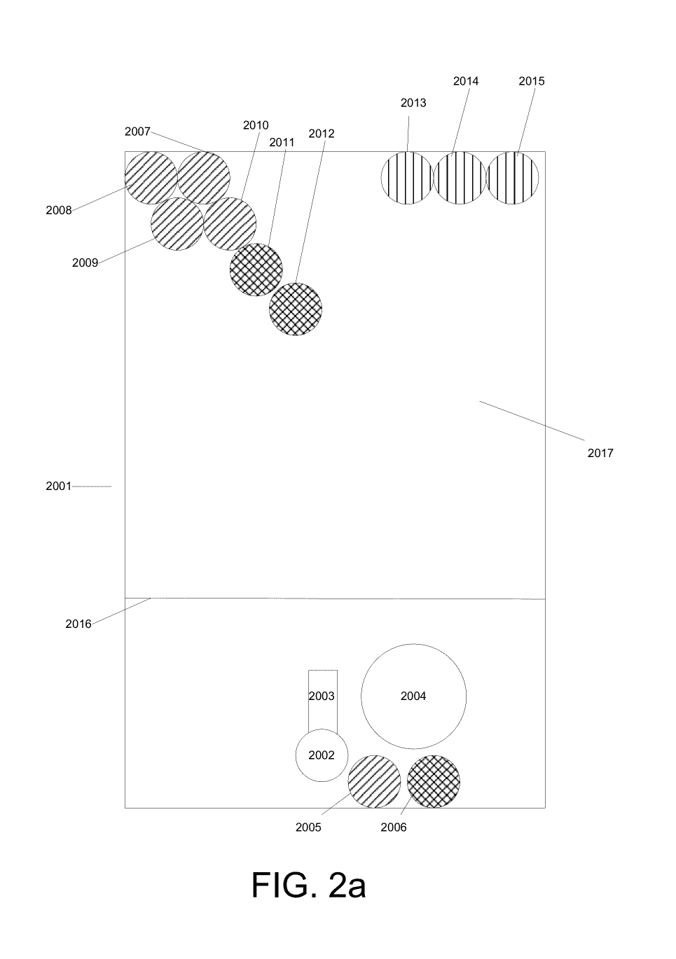

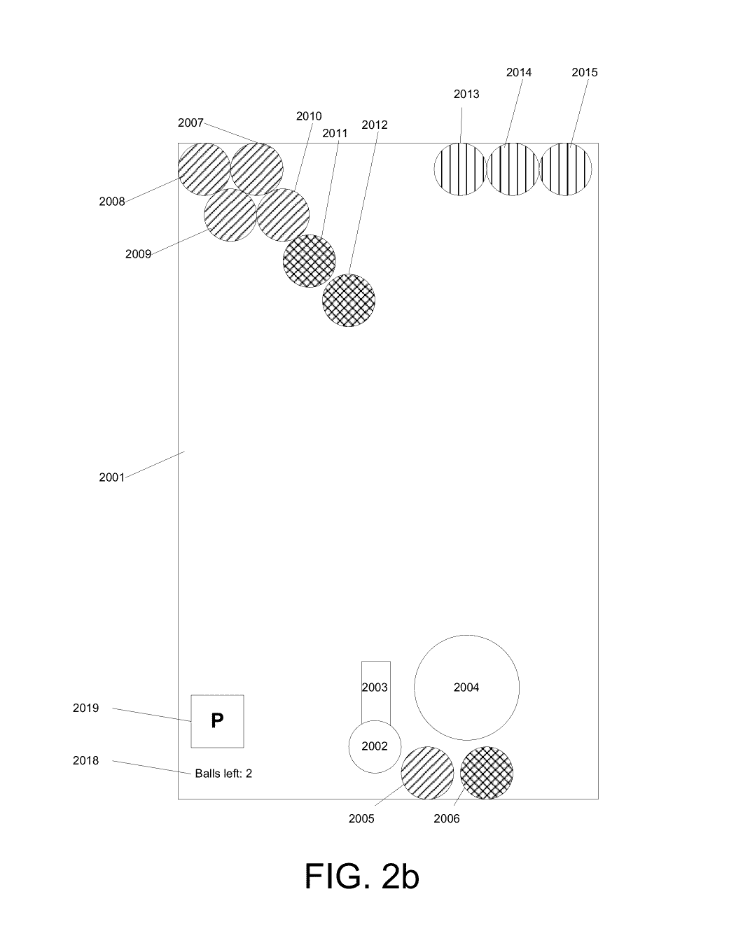

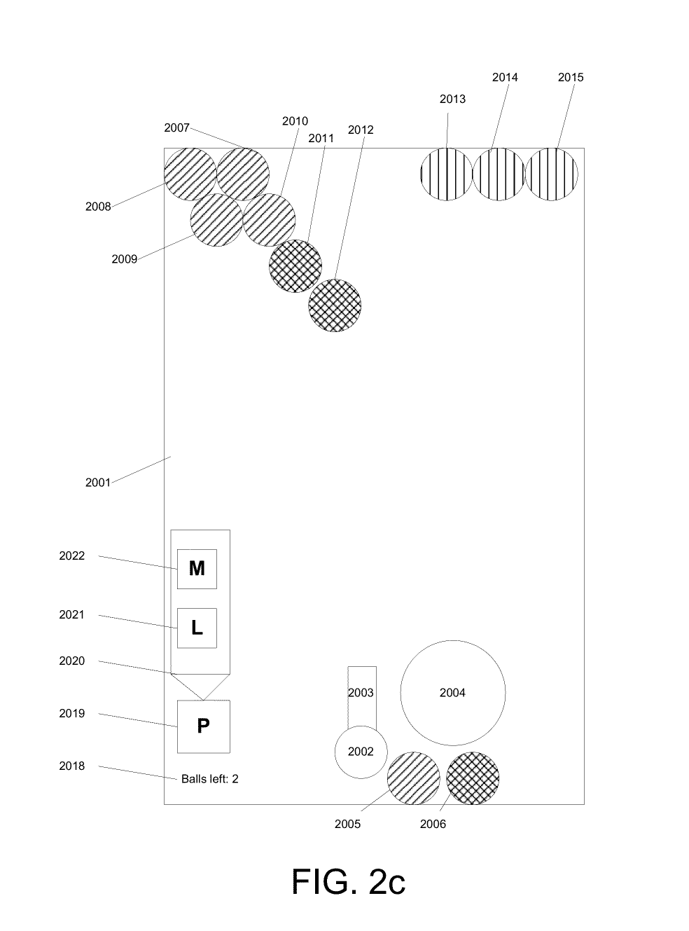

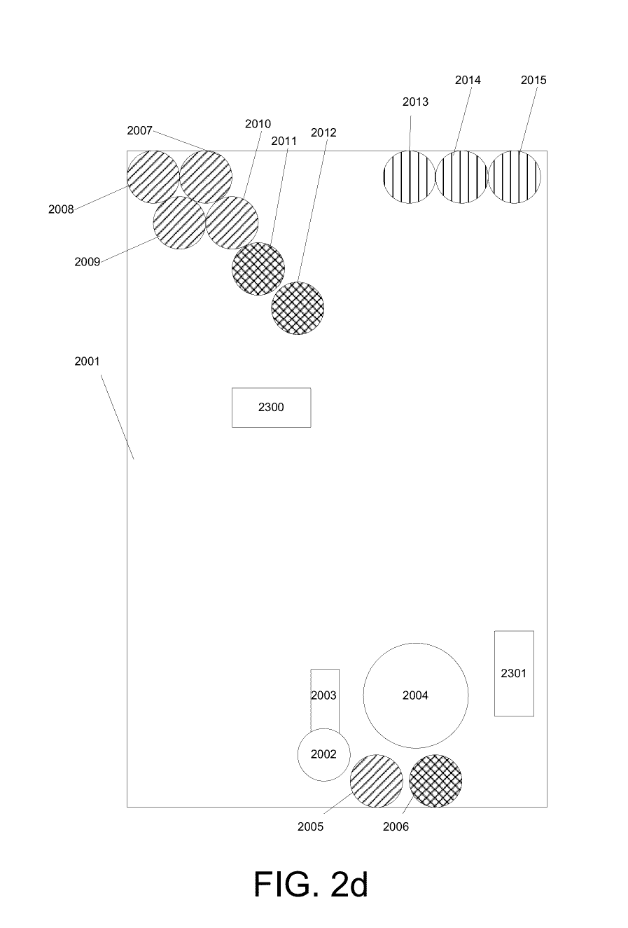

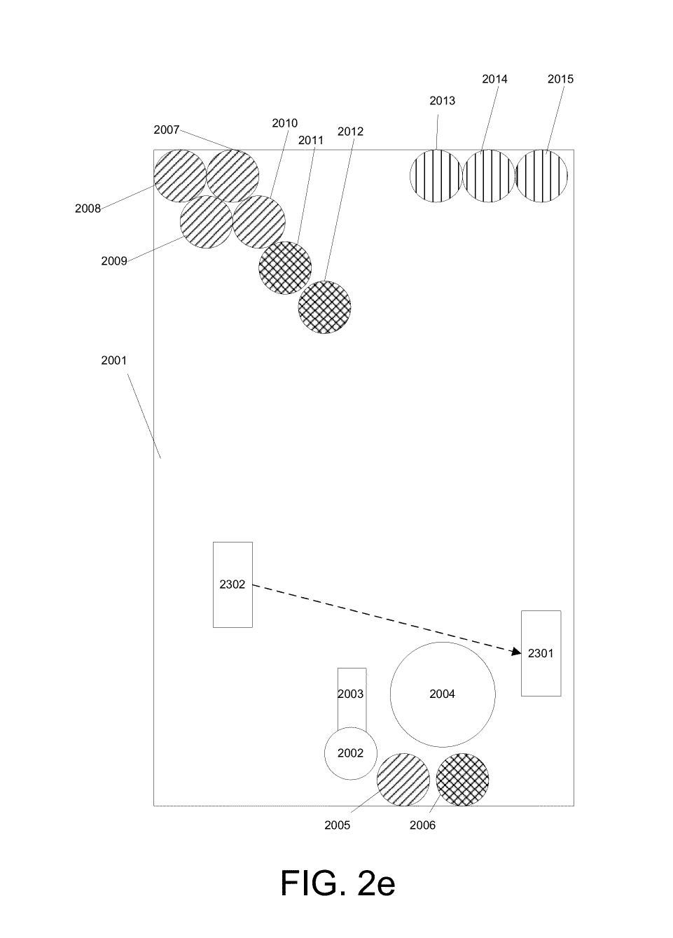

FIG. 2a illustrates and example of a game that could be played in an asynchronous manner. The game is a match-three game, that is a game requiring the user to match three similar objects. In this case, the user will be matching three bubbles of the same color, hereinafter referred to as the “bubble game.” A user could play this game on a client device where the game is visible on the display area 2001 of the client device. In this case the display area 2001 is represented in a rectangular shape, such as that of a smartphone, but, the display area could be of any shape. The bottom of the screen contains the base 2002 of a cannon 2003. An avatar 2004 may be situated near the cannon 2003. Two bubbles 2005 and 2006 may be situated ready to be fired by the cannon 2003. The bubble that is armed 2005 may be fired by tapping anywhere on the screen or display area 2001. The next bubble 2006 to be armed may be swapped into the active position if the avatar 2004 is tapped.

In the description of the various embodiment, it will be assumed that this usage is on a smartphone, and therefore, a user may make interactive motions with his finger. However, any user interface interaction could be used for any of the example embodiments. For example, if a user were playing the bubble game on a computer with a mouse, then the avatar 2004 in the game would be “clicked” on using a mouse button.

In the bubble game, there may be an assorted number of balls that are represented by either color or by pattern, as seen in FIG. 2, or a combination thereof. Colors may be used by themselves, or patterns may be added on top of the colors for those players that are colorblind. Balls may be attached to each other or hanging off the ceiling in a pre-defined manner and stored in the game as an array indicating the type of bubble, pattern, color, position, and adjoining bubbles. The bubbles above the “end game” line 2016 are considered to be on the bubble board 2017, which is the space within the screen that is above the end game line 2016. Any balls that are fired from the cannon 2003 that are attached to the ceiling or other bubbles are stored as part of the bubble board 2017. The end game line 2016 indicates the lowest point on the bubble board. In some instance, going below the end game line 2016 will end the game; however, in other instances, going below the line may simply trigger an event, such as resetting the board or deleting the board a predetermined number of rows above the end game line 2016. The number of different colors and/or patterns of bubbles may vary. As seen in FIG. 2, on the bubble board there are three patterns, group 1 bubbles 2005, 2007-2010, group 2 bubbles 2006, 2011, 2012, and group 3 bubbles 2013-2015. If a bubble loaded in the cannon, such as bubble 2005, were fired onto the bubble board 2017 and touched either the ceiling or another bubble that was not connected to at least one other bubble of the same color (i.e. for a match three game), then the bubble would simply attach to the bubble board 2017 at the point of the first other bubble or ceiling it touched. On the other hand, if the bubble 2005 were to touch another bubble of its own color and/or pattern (depending on the requirement of whether a match must be both the color and the pattern or either the pattern or the color), then all bubbles of like type (pattern and/or color), would be considered matched and therefore disappear together. In FIG. 2, bubbles 2007-2010 would disappear if 2005 were to touch the group. Moreover, any balls that would now not be touching another bubble that is attached to the ceiling, such as bubbles 2011 and 2012, could drop or in other embodiments could disappear.

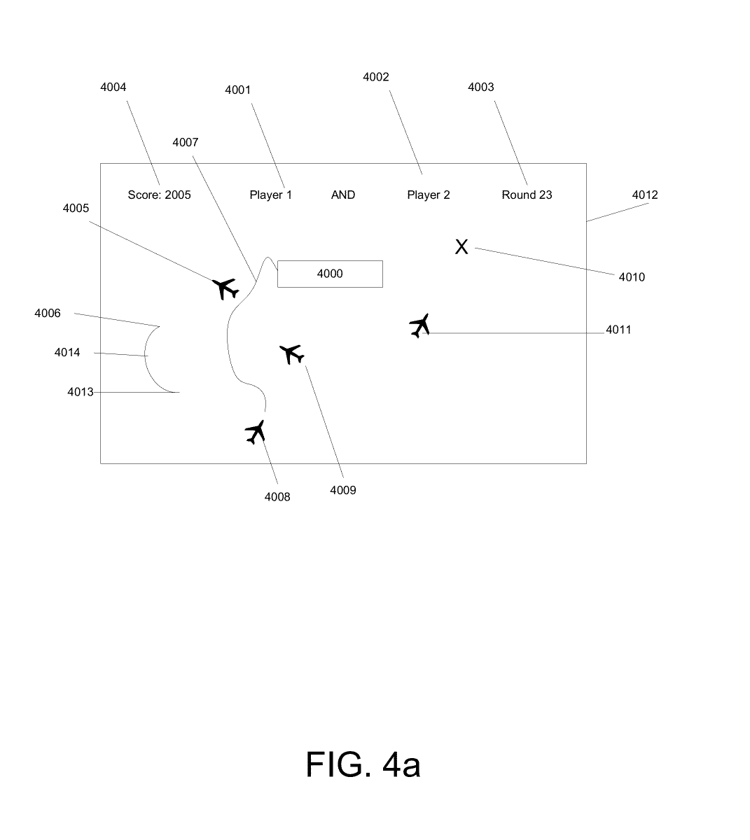

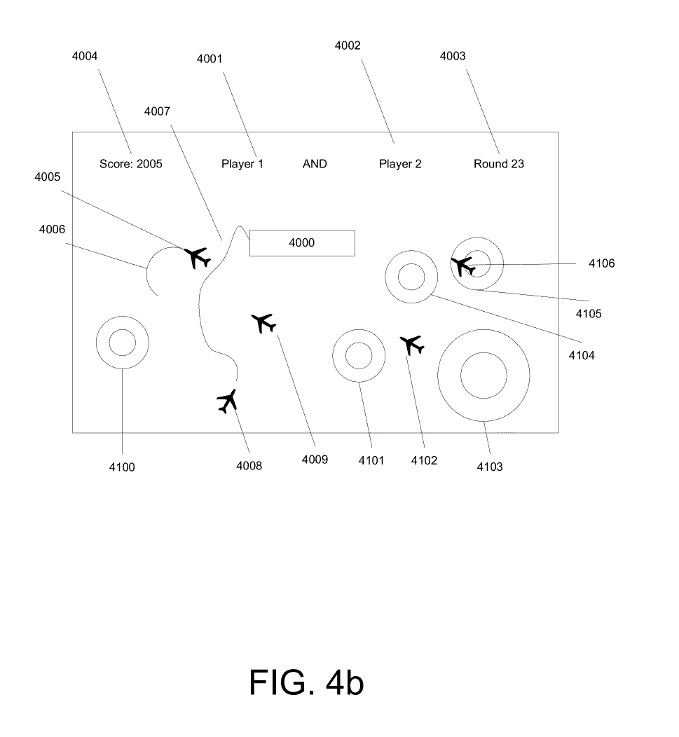

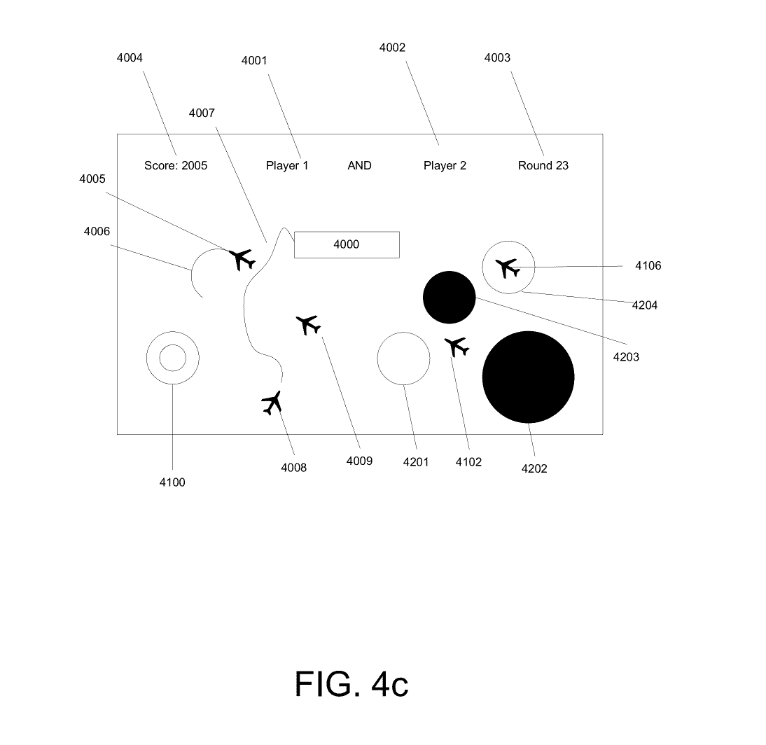

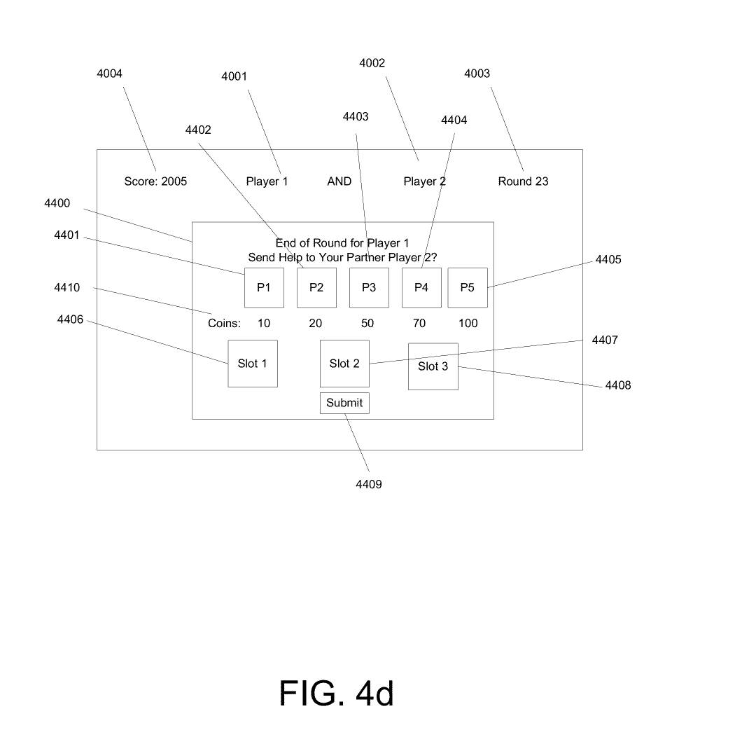

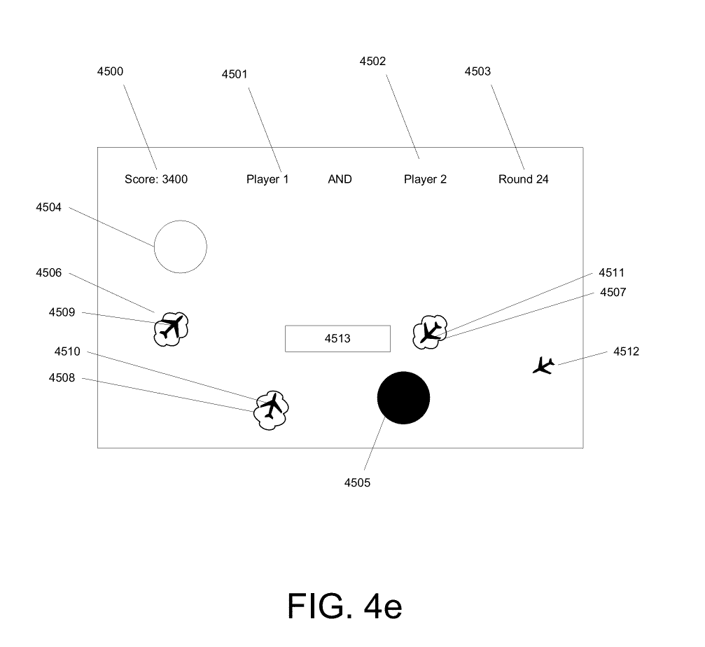

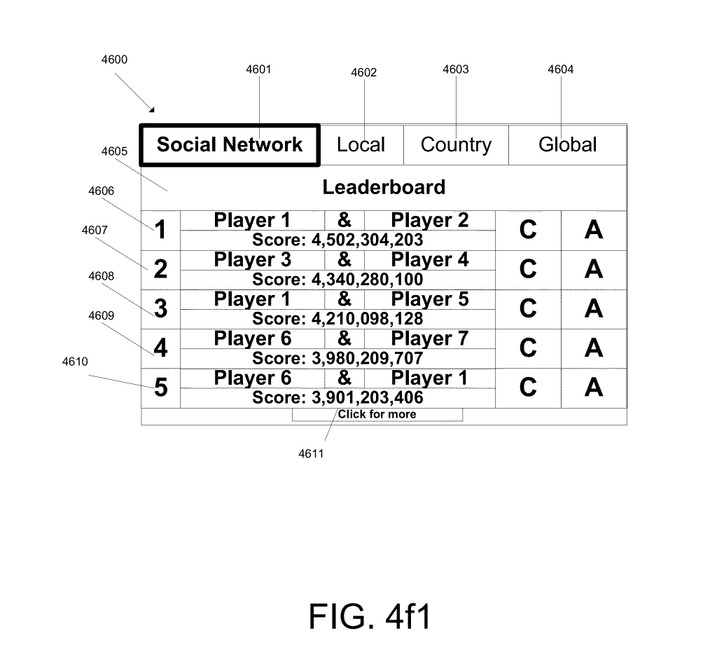

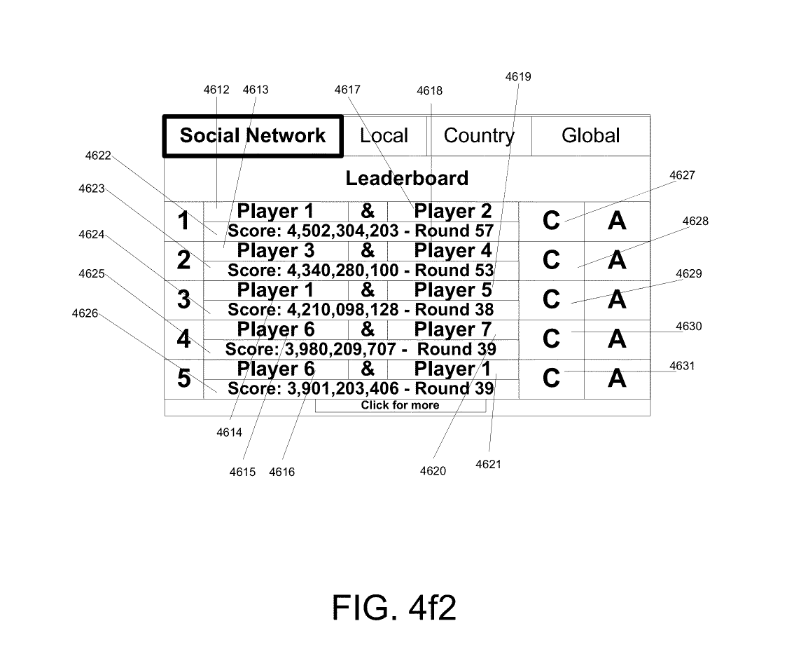

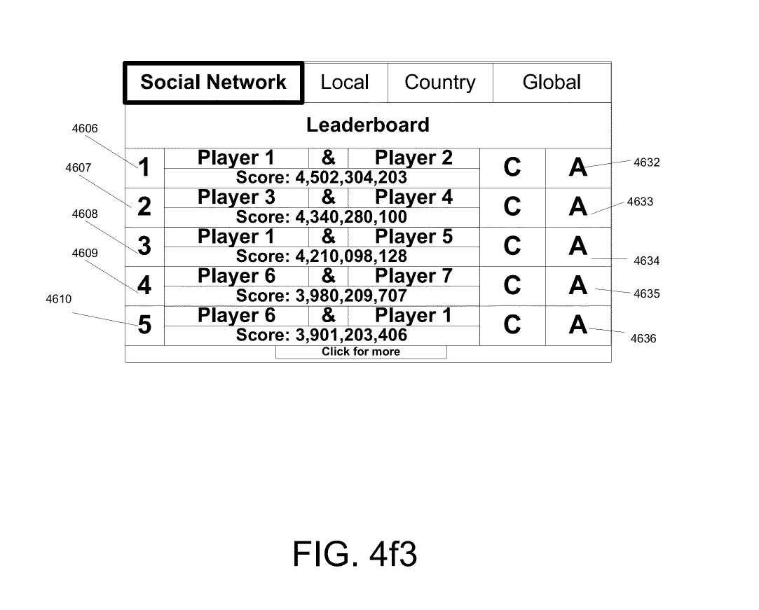

FIG. 2b illustrates an example of how a non-core feature, such as powerups, may apply in the game. FIG. 2b has the same bubbles as FIG. 2a. In this example of the game, there is a limit in the number of bubbles that a user is given to complete a board, where the limit of the number of bubbles issued is in a “bubbles remaining” text box 2018. In the “bubbles remaining” text box 2018 the number indicates the number of balls remaining, which in this case is 2. A user could tap or click on the powerup icon 2019, which would open a menu as shown in FIG. 4.

FIG. 2c illustrates how, building off the examples of FIGS. 2a and 2b, the powerup menu containing non-core features to the gameplay may appear to a user. In this particular example, after the user pressed the powerup icon 2019 to produce the powerup menu 2020, the user may have non-core features of the laser button 2021, represented by the letter “L”, and the “more balls” button 2022, as represented by the letter “M”. These are considered non-core features because they are not part of the base gameplay, and if a user never used the powerups they could still play the game. However, in this case, if a user were to press the laser button 2021, he would activate the laser powerup, which in this case may be the path of where the armed bubble 2005 would travel after being shot out of the cannon 2003. The “more bubbles” button 2022, when pressed will provide the user with “more bubbles” and increase the count in the bubbles remaining text box 2018. The number of additional bubbles that the player will receiving in that turn may vary. The additional bubble given to the user is not shown in FIG. 2c, as only two bubbles are actively shown to the user per this particular example. In example where all the bubbles a player has in the round are shown, the bubble would appear when the “more bubbles” powerup button 2022 is activated.

FIG. 2d illustrates, building off the examples of FIGS. 2a through 2c, the powerup non-core feature is active and displayed in a player's screen. In one example, a flying powerup 2300 is a blocking asset and could be activated by an external player. For example, the flying powerup 2300 could be represented by an owl that flies back and forth horizontally across the screen. As the user attempts to shoot the active bubble 2005 into the corresponding group of balls 2013-2015, the flying asset 2300 may deflect the ball down and out of the screen. In another example, a stealing powerup 2301 could be activated by an external player. In this instance, the stealing powerup 2301 could be represented by a ferret and come in to steal the active bubble 2005 or the next bubble 2006. In the examples, one or both of the powerups 2300 and 2301 could be activated at a time, and in other examples, even more powerups could be activated. The number of balls stolen by the stealing powerup 2301 may vary, and the number of times the flying powerup 2300 flies across the screen may also be varied. For example, the flying powerup 2300 may constantly be on the screen the entire opponent's turn and flying back and forth at a constant rate. In other instances, the flying powerup 2300 may be flying back in different directions at a random sequence. In other examples, the flying powerup 2300 may fly across the screen and disappear momentarily and at a random (or possibly constant) intervals reappear on the screen.

FIG. 2e illustrates, building off the examples of FIGS. 2a through 2d, a powerup non-core feature that is activated by the opponent and displayed in the second player's screen to counteract the non-core feature activated by a first player. In the example, only the stealing powerup 2301 is shown to be activated. As previously described, the stealing powerup 2301 in the example may be a ferret, or any other animal that has the characteristics of being able to be sneaky. The second player may activate a defensive bubble protector powerup 2302 that moves in the direction of the dotted line to attack the non-core feature that was activated by the first player. The defensive bubble protector powerup 2302 may be represented by another animal, such as a coyote, the natural enemy of the ferret. When the non-core feature of the defensive bubble protector powerup 2302 is activated by the second user, the first user's non-core feature of the stealing powerup 2301 may be rendered ineffective or partially ineffective, depending on the setting of the game system. For example, the powerups effectiveness may depend on the level of the powerup activated by the first user. If the first user is a higher level user or if the powerup is a higher level powerup, then the defense may only be partially effective. If, on the other hand, the game settings simply allow powerups to be completely countered, then once the defensive bubble protector powerup 2302 is activated, the stealing powerup 2301 is no longer effective.

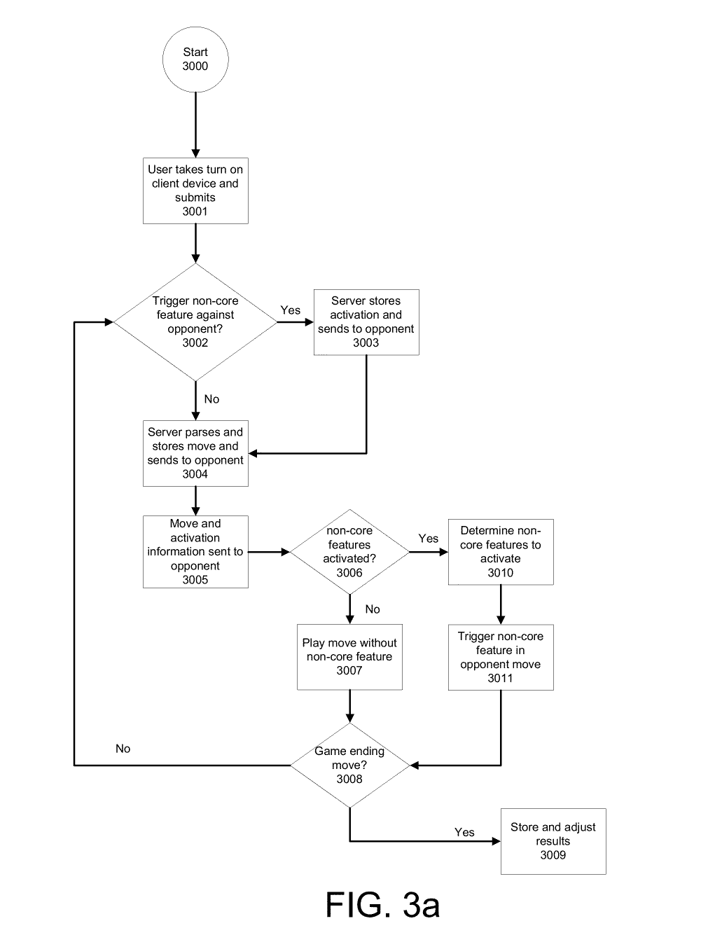

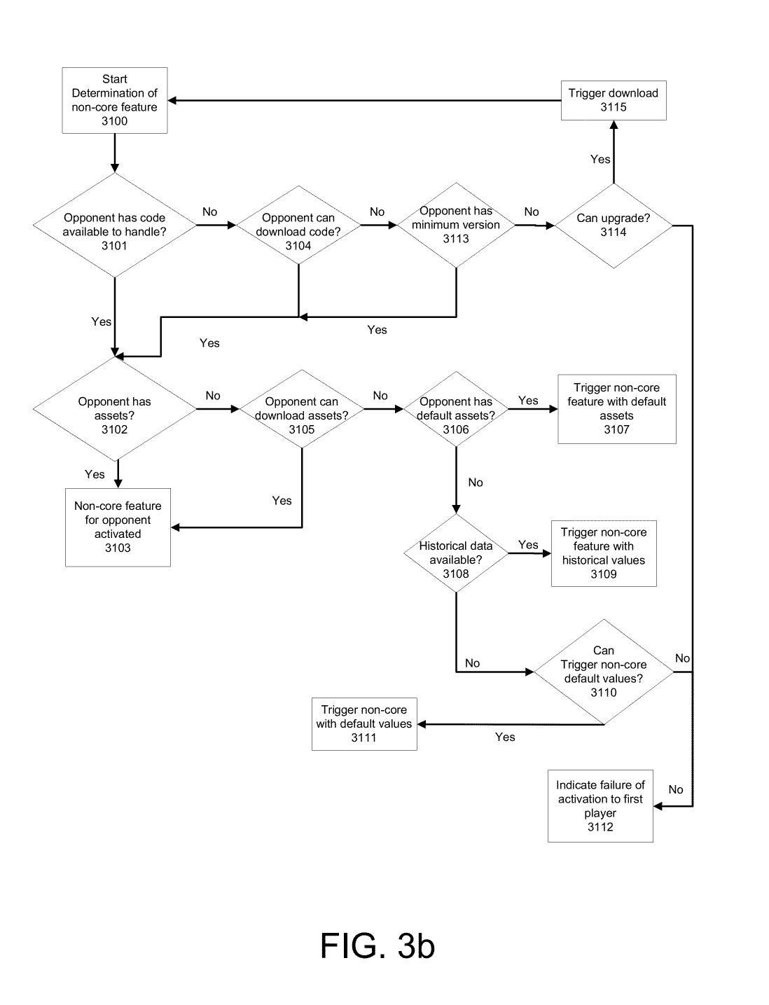

FIG. 3a depicts an example process flow of how non-core features may be activated by an external user. After a first user starts the application 3000 and enters a game with a second user, the user can take his turn in the game and submits the move on the client device 3001. The client device then displays an option for the first player to activate a non-core feature in the second player's turn 3002. If the first player chooses to activate the non-core feature 3003, the activation information is sent to the server for processing and storage. Afterwards, the move is also sent to the server for processing and storage 3004. However, if the first user had chosen not to activate a non-core feature in the second player's move, then the server would have directly processed and stored just the move 3004. In some instances, sending of the move and the activation information would be sent together; in other example instances, the move and activation may be sent and store separately. For example, a system may want to receive the move first so that it can process the move and indicate to the second user that a move is available. This may be beneficial in instances where a non-core feature must be activated by a time limit. However, in other instances, where a first user has time to choose whether to activate a non-core feature, the system may require that both the move and activation flag and activation data are sent together.

In 3005, the first user's opponent (the second user), now receives the move information about the first user's move as well as any activation information. If a non-core feature was activated, then the second user simply can make his move 3007. If the second player's move was not determined to be a game ending move 3008, then the move is sent back to the opponent (in this case the first user) and goes through the process 3002, this time from the perspective of the second user sending the move and potential non-core activation to the first user. However, if the determination is made that the second user made a game ending move 3008, either because the turns ran out or the user made an action to end the game, such as a win or lose scenario, then the game is completed. The results are stored and adjusted 3009. Adjustments could mean the users' win/loss record is updated, if there was a particular score that was worthy of leaderboards, then the users' rankings are changed, etc.

However, if in the asynchronous game, the second user is playing a move in which a non-core feature was activated, then the system would first determine which non-core features were activated 3010. The system then triggers the non-core features in the second player's move 3011, which is described in more detail in FIG. 3b. After the completion of the opponent move 3011, the same determination of game-end state is made 3008.

FIG. 3b depicts an example process flow of the determination of non-core features to activate and the activation of those figures, or an example of a more detailed process flow of the example processes of 3010 and 3011 of FIG. 3a. In FIG. 3b, the process starts the determination of non-core features 3100. In the most ideal state, where the opponent, in other words the second player, has the source code, files, hardware, necessary to process the activation of the non-core feature 3101 that was activated by the first player, then there must be a check to see if the corresponding assets related to that code is also available 3102. For example, in some instances, the code to activate the non-core feature may be the same for various assets, where assets may be pictures, sounds, or other non-code related components. In FIG. 2d the flying powerup 2300, as an example, may be linked to various art assets, for example a sprite table, as well as a sound asset of any format. For example, the sound asset could be one of or a combination of a way, mp3, or any proprietary or non-proprietary format. Therefore, if the flying powerup 2300 were an owl, then the sprite table may be an owl in various forms of flight with its wings flapping at different angles, while the sound format may be different sounds, such as the “hoot” of an owl as well as the squawk of an owl getting hit. If the assets related to the code 3102 were available, then the opponent would be able to have the non-core feature activated by the first player to be displayed on the opponent's device 3103.

On the other hand, if any portion of the code or assets were missing, then alternative methods may be initiated to ensure that the first player's activation was acknowledged. The first player may have paid virtual currency to enable the non-core feature activation of the second player; therefore, the first player may want to ensure that the non-core feature activation actually occurs. If the opponent does not have all the code 3101 or assets 3102 to handle the full activation of the non-core feature 3103, the system may still be able to ensure the activation of the non-core feature to the same effect. For example, if after the determination that the opponent does not have the code 3101, the system may determine whether the not the opponent is capable of downloading the portion of the code that is missing 3104. If the opponent is able to download the portion of the code, or other information needed to process the activation of the non-core feature, then the code is downloaded for the opponent and then the determination is made again to see if the opponent has the appropriate assets 3102. In the previous explanation, the opponent has the assets from 3102 and, therefore, the non-core feature was able to activated.

If in the event the opponent did not have the assets, then a determination would have to be made as to whether the assets could be downloaded or obtained in some way 3105. For example, the assets could be downloaded over the air (OTA) from the provider of the application of the game, pre-stored in another server of a third-party server or market of the application, or downloaded directly from the client device of the first player that is activating the non-core feature. For example, there may be a non-core feature activation that used the assets of the camera of the client device. In other words, the image asset is a picture taken from the client device of the first player. In such a situation, the image may be uploaded to the game server first and then downloaded from the game server by the second player. In another instance, the client device of the first player may directly send the information as a network packet, for example, as a JavaScript Object Notation (JSON) Binary Large Object (BLOB), short message service (SMS) data packet, through a push notification (PN) data packet, a network packet over bluetooth, or any other number of communication. Similarly, for sound data, the data may be a recorded sound on the first player's device that may be sent from the first player's client device or uploaded to a server. Alternatively, the sound may be a pre-made sound of the game application that is pre-stored.

If the opponent is able to download the assets 3105 through any of the example processes mentioned above, then the non-core feature activated by the first player may be shown and applied to the opponent's move 3103. If the opponent is unable to download the assets, it may still be possible to activate a form of the non-core feature. For example, a determination can be made if the opponent has default assets 3106. These assets may then be used in place of the main assets but to serve the same purpose. For example, in FIG. 2d the flying powerup 2300 was mentioned to be an example owl with an associate sprite table of owl flight assets. If the flying powerup 2300 had multiple varieties, such as a hawk, an eagle, etc., the system could determine that one of the assets was the default asset should the opponent not have the other assets. In this example, the default asset could be the hawk. If the hawk asset is adequate to serve as an asset for the non-core feature, then the opponent may be displayed the non-core feature with the default asset 3107 rather than the main asset.

If, on the other hand, the user does not even have default assets, then the system may still try to apply the non-core feature by obtaining historical data. For example, the client (or server downloaded to the client) may store historical data about the user behavior in other non-core features. Alternatively, the client may obtain user data across an aggregate of a larger user base. In this way, a default set of historical values may be obtained about the effectiveness of the activation of non-core features. For example, in the bubble example of FIG. 2d, data may be obtained from historical data specific to the opponent, either stored on the client or stored on the server. If the system determines that non-core feature activations are specifically effective 20% against the opponent, then the system may assume that, in the example of the flying powerup 2300, that a hypothetical amount of 20% of the opponent's balls would have been deflected. The system then may take general aggregate data and determine that when 20% of the balls are deflected, a user's score is decreased by a range of 2300 to 5000 points (depending of course on the scoring methodology). In this example, the server could always take the lowest range in a sense of fairness as the user was not able to actually play with the asset in place, or it may take the highest range in a sense of fairness to the first user to punish the second user for not having up-to-date code and assets, or it may alternatively take a random amount between the range. In the example, the system used both a user specific historical value and a server-side aggregate user historical value and applied it to create a range. Depending on the type of non-core feature that is activated, the system may determine that only user-specific data is used or only server aggregate user data is used. Alternatively, a combination of data may be used. For example, if the opponent used his own powerup, such as defensive bubble protector powerup 2302, to counter that of the stealing powerup 2301, then it may render the first opponent's activation of the powerup ineffective or partially ineffective, depending on the setting of the game.

Based on the example above, if the historical data is available 3108, whether server or client and whether user specific or user aggregate, then the system may be able to still trigger the non-core feature using the historical values 3109. Alternatively, if a determination of the availability of historical 3108 indicates that none is available to satisfy the trigger of the non-core feature, then a determination is made as to whether any default values were available 3110. For example, there may have been values input that were hardcoded indicating that by default any non-core feature that was ever unavailable was always 30% effective. If such default values were available, then the non-core feature would be triggered with the default values 3111. If even these values were unavailable, then the system would indicate to the first and second player that the non-core feature was unable to be activated 3112. In this way, at the very minimum, the first user could possibly receive a refund for any actual or virtual currency was applied to the activation of the non-core feature. Moreover, if the system was fair to the first user, then the first user would trust the system more to be able to activate other non-core features that may have been available to the opponent. For example, the first player could be able to trigger the non-core feature up to 3103 for the example flying powerup 2300 of FIG. 2d. However, in the same turn for the opponent, the system could fail to reach the most ideal state 3103 and is only able to reach one of the secondary states 3107, 3109, 3111 for the example stealing powerup 2301 of FIG. 2d.

There may be an instance where the determination of whether the opponent can download the code 3104 indicates that the opponent may not even be able to apply any of the default behaviors 3107, 3109, 3111. In such case, the system determines whether the user has the minimum version of the code available 3113. If the opponent does the have the minimum version 3113 then it can go through the process to check if it has the proper assets 3102. If the opponent does not have the minimal version to be able to do the default processes of running the non-core features activated by the first user 3107, 3109, 3111 the client may be forced to upgrade or download of the application 3115 to either the most recent version, or in some cases the minimal version of the application needed to run the non-core feature. First, however, the system must determine whether an upgrade is possible 3114. For example, in some instances, the most recent versions of the application needed to run the non-core feature may not be available on the operating system (OS) of the opponent's client device. In such an instance, there may be no option but to indicate the failure of the non-core feature activation 3112. If the system is able to determine that an upgrade is possible 3114, it may force an upgrade to the most recent version. Alternatively, the system may simply force an upgrade of the most minimal version that is capable of running the non-core feature. Or, alternatively, the system may have to force an upgrade to the most recent version that the opponent is able to run, that is the most recent version that allows that the opponent's OS to be capable of activating the non-core feature.

In the example processes above, where the system is determining whether the opponent has code, the check may be done either on the client or the server. A check may be done on the client by performing a client-to-client communication to compare version numbers of the application. Alternatively, a checksum may be preferred by the client against an n-bit file to determine if any flags indicate that the client is missing files. Alternatively, the client may simply have a number storing the most recent version or a list of all the versions.

As mentioned above asynchronous games can be played PvP, with two players in the closed game, team versus team, or player vs. team. However, in alternative embodiments, the asynchronous game may be played by two players trying to achieve a high score together rather than playing against each other.

FIG. 4a illustrates an example of a game that could be played in an asynchronous manner as a team. In the example gameplay, hereinafter referred to as the flight game, there are various graphical user interface (GUI) texts that are on the main screen 4012 that is visible to a user, and in the example it is player 1's turn. Another GUI text states who the members of the team are, such as the first team member text 4001, in this example “player 1” and the second team member text 4002, in this example “player 2”. The two players are a team in this example and the score for the current round, as displayed in the round text 4003, is the score text 4004. In the game, there are multiple objects that the user has to control, in this example, they are airplanes 4005, 4008, 4009, 4011. The user can control the airplanes through a variety of different mechanisms. For example, if there were a control pad with arrows (not shown), the user could direct the airplanes by touching a plane and controlling it. Alternatively, a user may have an input using a tap. For example, on the example screen, plane 4011 responds to a user tap, represented by the “X” 4010 marking the location of where the user tapped. The “X” 4010 may or may not be shown at the location, and the tap may be represented by any number of symbols to the user, such as a rippling animated circle from where the user tapped, a triangle, etc. Another alternative method of input is a swipe where, if the input is a touch screen, the user can touch the plane that he would want to control and can leave the finger on the screen and trace out a path and lift his finger off the screen. The traced path may or may not be shown to the user, but the plane follows the path from the traced line. In the example, the plane 4008 is following the traced path 4007 to enter the target landing area 4000. In the example gameplay, each plane is only able to be hit once. Therefore, if any of the planes crash into each other or is hit by a missile or other projectile, then the game is lost. The goal or win state of the game, is to be able to survive the planes on the screen and direct them toward the target landing area 4000. In another alternative example of the input, for example, if the input was a mouse, a user could click on the plane he wants to control and then trace out a path on any other area of the screen and the plane would go towards the start point and follow the path to the end point of the path. From there, the plane would move in a straight line, or possibly along the curve it traced last, or in a random fashion. For example, plane 4005, could be following a path 4014 created away from the plane 4005. The plane 4005 would first go in a straight line towards the starting point of the line 4006 and trace the path 4014 toward the endpoint of the line 4013 before moving in a straight line. In another example, plane 4009 has not been directed by a user or the plane has finished moving along the path given by a user. In this instance, the plane moves in a constant straight line; however, in another example gameplay, planes that have not been given a direction may move randomly around the screen.

If the flight game were solely a single player game, the user could achieve a win-state by either surviving a round without losing any planes, or to send all the planes to the target landing area 4000. In the general case where a plane, such as plane 4005, is going to the edge of the screen and actually hits the edge, the gameplay may bounce the user off the wall to come back towards the center of the game screen. Otherwise, when there were planes on the screen, a user could simply avoid collisions by sending them all away. On the other hand, in an asynchronous game, such as the example shown in FIG. 4a, where players are playing as a team, a user may be able to direct a plane to the edge of the screen. Instead of “bouncing” off the wall and coming back, the plane may be designated as having been “sent” to their teammate. For example, if plane 4005 were sent away by player 1 to player 2, player 2 would see plane 4005 in the next round when he is playing his turn. There are many examples of how example plane 4005 may appear. For example, if the rounds are time-based, the plane could appear at the same “moment” that the plane was sent out. For example, if plane 4005 was sent out at forty-five seconds into player 1's round, then at the forty-five second mark of player 2's round, plane 4005 may appear. For scoring purposes, planes sent to other players may be treated differently. For example, if scoring were based on how quickly a plane was landed in the target landing area 4000, then any plane sent to another player may be given a default penalty time. Moreover, players may be prohibited from sending to other players planes that were sent to them. Therefore, in the example, if plane 4005 appeared to player 2, as sent from player 1, and was designated as such by some indicia (e.g. a different color, a different size, an outline, etc.), then player 2 may be specifically prohibited from sending the plane off the screen back to player 1, though player 2 may be able to send other planes to player 1.

FIG. 4b illustrates an example of the gameplay that could be played in an asynchronous manner as a team with a non-core feature activated. As explained previously, the main gameplay of the flight game, in the particular example, was to get the planes onto the target landing area 4000. The main game mechanics of the game were defined by what was needed to play the game and achieve the win-state in a particular user's turn. This is defined by the game rules itself. For example, non-core features may affect the win-state by affecting the points of a user or user behavior, but the actual non-core features are actually defined by the rules of the game itself. If the rules of the game are, for example in the case of FIG. 4a, defined as the set of planes reaching a target landing area, then those are the core features that are part of the main gameplay. If a set of weapons are introduced that are not needed to be used, but are defined in the rules as being part of the main gameplay, then those elements are part of the game play and are “core” features, even if they are not actually needed to be used to get through the game. In an asynchronous turn-based game, however, a feature that is activated by an external user to be activated not on that external user's turn, but during their opponent's turn, is a non-core feature, regardless of whether sending the activation is part of the core gameplay. This is because the feature is not actually core to that user's turn.

For example, if there were an FPS in capture-the-flag mode, a weapon may be a core-feature if it is defined as the base equipment; however, it is possible for a user to win a capture-the-flag game by simply capturing the flag and never using the weapon. Nevertheless, because the game defines having a weapon as one of the basic equipment of the game, it is a core feature. Alternatively, in an async game example, the non-core features are those that are paid for with virtual currency, or optional even if free. Essentially, those designated as “optional” features for a user are non-core features, unless selecting one of several items is necessary to get to the win-state of the game. Or where a feature does not require involvement, as in a leaderboard challenge, as will explained later, if another user activates a feature through a leaderboard, the feature activated would be non-core because any user could activate it and they are externally involved in the game, though a first user could still play on his own game and turn without necessitating or having one or more external users activate a feature as a gate to the first user taking his turn.

Going back to the example in FIG. 4b, which builds off the screen from FIG. 4a, there is a feature, hereinafter referred to as the memory targeting system. In a typical game, an enemy may have the targeting displayed to a user, either view a circle, crosshairs, etc. The actual weapon (e.g. punch, bomb, arrow, etc.) hits the location of where the target was by replacing the hit. The memory targeting system is a novel gameplay wherein the targeting is treated like a memory game. In the example of FIG. 4b, the targets 4100, 4101, 4103, 4104, 4105 are displayed to the user at different times. The targets may be of different sizes, as seen in example FIG. 4b target 4103 is of greater diameter than the other targets 4100, 4101, 4104, 4105. It is possible that the targets stay on the screen based on their size, for example, the larger target 4103 stays on the screen for a fixed time of two seconds compared to a smaller target 4100 which may stay on the screen for one second. Alternatively, all targets stay on the screen the same amount of pre-determined time, or, alternatively, targets may stay on the screen within a range, which may or may not overlap. For example, the larger target 4103 may be displayed for a period of between three to five seconds while a smaller target like 4100 may be displayed between one to three seconds. After the targets are displayed, the targets disappear from display to a user, either completely disappearing or fading from view. As seen in FIG. 4b, the targets may appear in parts of the screen where there are already planes, such as target 4105 covering plane 4106, or possibly plane 4106 flew over the target 4105.

FIG. 4c illustrates an example of the memory targeting system in game that could be played in an asynchronous manner as a team, building off the example from FIGS. 4a and 4b. In FIG. 4c, all of the previous targets 4101, 4103, 4104, 4105 have disappeared from view except for target 4100. This is because the targets that come down all appear at different times. In fact, there may even be a sound pre-target, such as a cannon fire sound, to indicate a target is about to appear. Since the targets appear at different times, the targets also disappear at different times. In the example in FIG. 4c, the targets that have disappeared will have an attack of some kind appear where the target was. However, rather than having the target replaced by an attack. There is a specific delay in-between the target disappearing and an attack appearing. The disappearance of attacks is represented by the disappeared targets 4201 and 4204, which replaced targets 4101 and 4105, respectively. The disappeared targets 4201 and 4204 are shown in FIG. 4c for purposes of explanation; however, in the actual visual display to a user, the area would simply be what is shown in the background or on the screen, such as a plane, and the target will have been removed. The disappeared target 4201 and 4204 will be disappeared for a pre-determined period of time, much like the amount of time that the targets were on the screen. The pre-determined period may be determined in the same manner, for example, based on size, based on a random time within a range, or a combination thereof. Finally, the black circles represent where the actual attacks 4202 and 4203. Here, the attacks occur after the targets have first appeared and the targets then disappeared for a period of time. The reason this mechanic is the memory targeting system, is because the user is shown where the attacks will occur with the target, thus allowing the user to move the planes to avoid the attack; however, with the removal of the target the user will have to remember where the target was. This becomes particularly difficult when there are many targets appearing and disappearing at the same time. Sometimes, targets may even overlap with where an attack would be or where a disappeared target is, making the situation even more confusing. A user would have to possibly maneuver a plane over a target because other areas of the screen will having attacks occur soon, and then have to quickly move the plane off the target after the attacks have occurred.

FIG. 4d illustrates an example of the screen for a user to activate a non-core feature after the end of their turn. For example, the screen represents the end of the round for player 1 and still contains the same GUI texts from FIG. 4, such as the score text 4004 and the round text 4003. A popup window of the round end menu 4400 appears to player 1. The player now has the option to send various powerups P1 through P5 4401 through 4405, respectively, to help his teammate, in this example, player 2. The powerups cost different amounts of virtual currency, wherein the price is shown in a price text 4410. Each price under the powerup corresponds to the cost a player may have to spend in the user's virtual bank when moved into the active slots 1-3 represented as 4406 to 4408. A user may choose to put any combination of powerups 4401 to 4405 into the active slots 4406 to 4408, including using none of the powerups or more than one up to all the slots. In this exemplary setup, a user is able to send one or more powerups to their teammate, and, of course, the maximum number may vary depending on the game. After a user has activated the powerups in the slots, they can press the submit button 4409 to send to the information to the server.

FIG. 4e illustrates an example of the memory targeting system as used in the flight game that could be played in an asynchronous manner as a team, and shown how an external user activates a non-core feature. In this particular example, the screen being show is that of the player 2, who is the second player shown in the second player text 4502. The screen displayed is otherwise similar to that of the screen shown to the first player. There is a score text 4500, the first player text 4501 containing the name of the first player, in this case player 1, as well as the current round show in the round text 4503. Building off the example of FIG. 4d, this screen is coming from a move sent by player 1 to player 2, as viewed by player 2. In the example, player 2 also has a target landing area 4513 with which to direct planes 4509, 4510, 4511, and 4512. In this particular game, the memory targeting system may be implemented with a disappearing target 4504, which is not actually displayed to a user, as well as an attack area 4505. In some instances, the attack area radius may actually differ from the original target area size. In this example, the memory targeting system is a non-core feature activated by external users, but in other exemplary games, the memory targeting system may be the core part of the gameplay itself.

FIG. 4e also illustrates the powerups that are activated by the external user that is the teammate. In FIG. 4d player 1 may have activated a protection powerup in any of the slots. A protection powerup is a defensive powerup in which protective bubbles 4506, 4507, and 4508 surround certain planes 4509, 4510, and 4511, respectively. The powerups used by one player to help a teammate may vary from game to game, round to round, and powerup to powerup. For example, protective bubbles may appear on all planes for a round in early rounds, but only appear on a random number of planes in later rounds. Alternatively, the defensive powerups may appear only on planes that were in the player's original game, but not any planes sent by the other player. For example, if player 1 sent plane 4512 to player 2 and also activated a protective powerup, the defensive powerup does not apply to plane 4512, as shown in FIG. 4e.

Though FIGS. 4a to 4e illustrate how a version of the memory targeting system may apply in an asynchronous turn-based team multiplayer game, the memory targeting system may also be used in alternative scenarios. For example, in a synchronous multiplayer PvP game, one player may be controlling planes while the other player is controlling the targeting system, with the delay and actual attack controlled by a computer or processor. In an alternative scenario, the memory targeting system may be used in an asynchronous turn-based PvP version, where a user can send the plane movement, and the opponent can control the memory targeting system. Or, alternatively, the memory targeting system is controlled by computer AI and the players simply determine the movement of the planes to see who can get their planes into the landing target area the quickest.

FIG. 4f1 to FIG. 4f3 illustrate the method in which an external user to a game can activate a non-core feature. In the prior example of the bubble game, the external users activating non-core features within a game were players playing against each other. In the flight game, external users were teammates to each other activating powerups to help each other. In the particular example in FIG. 4e, the activated powerup was a defensive powerup, but it could have easily been a powerup to help improve the score, a powerup to help slow down the speed of the planes or the rate at which planes entered, etc. The attacking non-core feature was the memory targeting system, and in the example, this would have been by an external user that was not involved in the particular game. FIG. 4f1 to FIG. 4f3 is the same leaderboard broken up into components for ease of description.

FIG. 4f1 shows an example leaderboard. The example leaderboard is displayed on the screen 4600. The leaderboard has various tabs that show the various types of leaderboards available, including a social network leaderboard 4601, a local leaderboard 4602, a country leaderboard 4603, and a global leaderboard 4604. Each leaderboard may be displayed to all users, or each leaderboard may require a user to achieve a certain level on one leaderboard before being able to view another leaderboard. For example, a user may be a part of many of a number of social networks but the social network tab 4601 may either be for a single social network, or may actually be a combination of various social networks. The leaderboard, as identified by the title text 4605, is displaying rankings of the highlighted tab, which, in the example, is the social network tab 4601. Currently, the rankings page also only shows the first five rankings, as shown in the rankings text boxes 4606 to 4610 showing rankings one through five, respectively. More rankings within a specific leaderboard can be either automatically shown when a user scrolls down the list, or require a user to proactively click or tap on a “click for more” button 4611.

In one example embodiment, a user may not be able to view the leaderboards (e.g. rankings) in the other tabs 4602 to 4604, unless he has achieved a high enough rank on the social network leaderboard. For example, a user may have to be ranked within the top five of their social network in order to view the local leaderboard. There may also be a minimum requirement that a user must have at least ten friends on their social network in order to prevent people from creating dummy accounts with no friends in order to be the top in their social network. A local leaderboard may be defined in any number of ways, where local is a state, a certain GPS region around where the user is located, an area code region on the phone, etc. The country leaderboard is the user's country and the global leaderboard is for all users in the world. There may be variations in the minimal ranking needed to be able to view these leaderboards as well. For example, a user who is within the top five of their social network may be able to view their local leaderboards under tab 4602, but may be restricted from their country leaderboards unless they are either in the top 1000 of their local leaderboard or within the top 10,000 of the country. The minimal number may also vary depending on the country as well. For example, for more populous countries, the minimal number may increase, whereas in less populous countries or with countries with less localities (i.e. states or other grouping method), the minimal number may differ. Moreover, for a user to be able to see the global leaderboard, they may be required to be within the top 5,000 in their country or be within the top 50,000 in the world.

The minimal requirement may require both be achieved or either to be achieved. For example, a game may require a user to be both in the top 5,000 in their country and top 50,000 in the world; whereas, a different game may require either being in the top 5,000 in the country or the top 50,000 in the world. The reason for limiting viewing is to spark a user to try for the leaderboard but not be too discouraged by higher scores. Leaderboards may be “all-time” or they may be reset at some pre-determined or random temporal interval.

FIG. 4f2, showing the same leaderboard from FIG. 4f1, further explains that each ranking spot contains a first player on the team and a second player on the team. The order may be chosen by any number of methods. For example, the first player could indicate the person's current turn, the player that scored the most points for the team, the player that started the game, etc. In the current example, where only five teams are listed, the ranking section has both first player texts 4612 to 4616 showing the first player names for the first five rankings, respectively. The example also shows the ranking section with second player texts 4617 to 4621 showing the second player names for the first five rankings, respectively. In the particular example, the social network tab shows the rankings of players that are in the user viewing the leaderboard's social network. In some games, both users on a team may be required to be in the player's social network; however, other games may only require that a team may be viewed in the ranking if only one player is in the viewing user's social network. Since a user is viewing friends on their social network, the real name of a user may be shown. However, in the case of teams with members that are not in a user's social network, the leaderboard may automatically only show a player's username. For example, if in the first ranking Player 1 was in a user's social network but Player 2 was not, then Player 2's username, which we will call “username2”, would shown in the second player text 4617. However, in some game settings, Player 2 may allow any user to view their real name, in such case, Player 2 may still be listed in the second player text 4617. The privacy issues may be of more importance when names appear in the other tabs, local, country, etc., and a user may be able to adjust his preferences for a real name or username to appear to other users in specific tabs or leaderboards, or potentially may be viewable to certain circles of users, such as friends only, friends of friends, etc.

The ranking measure texts 4622 to 4626 are shown for the first five rankings, respectively. The ranking measure texts in this example are sorted first by score and then by round, as seen from comparing the ranking measure text 4624 to that of 4625, where the higher score is ranked higher first, even though the round number that the team achieved is below that of the other team. The ranking measure text can display any type of measurements related to ranking and is not merely limited to score and round. In other games, there may be additional measurements that can relate to ranking. For example, in an FPS, the number of kills versus player deaths may affect a person's rankings. Moreover, the priority of measurements may differ depending on the game. For example, a leaderboard ranking could be set where the round number reached has a higher priority than that of the score.

Also in the example screen of FIG. 4f2 are challenge buttons 4627 to 4631 next to each team allowing users viewing the leaderboard to directly challenge a person of a specific ranking. In the specific example of the flight game, the players play as teams, so in this instance, it may be a user requesting to be on the same team as one of the top-ranked players. For example, when a challenge button 4627 is pressed, the player pressing the button may have the option to play on a team with either the first player 4612 or the second player 4617. However, in other asynchronous, turn-based, PvP games where only one user may be listed per ranking, a user could use a challenge button to directly challenge the player in a game.

FIG. 4f3 shows the same example leaderboard from FIGS. 4f1 to 4f2. In the example, the same first five rankings 4606 to 4610, respectively, are shown again. Next to each team ranking there is an attack button 4632 to 4636 next to each of the first five rankings 4606 to 4610, respectively. The attack button allows any user to activate a non-core feature in the game. For example, in the flight game, a user may be able to click on tap (depending on various input method or device) on the attack button 4632 to activate a powerup, such as a memory targeting system attack in the game of the first ranking team of Player 1 and Player 2. However, in other games, if the attack button is pressed there may be a variety of powerup attacks that a user may choose from in a menu and it is possible the users may also have to pay virtual money to activate the particular attack powerup. When any player is viewing this leaderboard, then the player can see who is ahead of them. When the game is not a PvP game, like that of the flight game, it may be even more important to affect a user through an attack button. In some games, a user does not enter the leaderboard until the game is ended and either a win or lose state is achieved. In other examples, such as the leaderboards shown in FIG. 4f1-3, the team enters the leaderboard as soon as they have achieved the ranking status. During this situation, an external user to the game, in this case a player that is neither playing against any of the players in the ranking or playing with any players in the ranking as part of a team, can affect the score of the players in that particular match. The ability to challenge users (or join with users as a team) or attack users in leaderboards may be even more important in others tabs, such as local or country, where the other players are not in their social network. Players who are looking for other high level players may use the leaderboards to make the game more interesting for themselves. The ability to activate non-core features has the same issues of making sure those users have the non-core feature ability, but may be solved using the same methods.

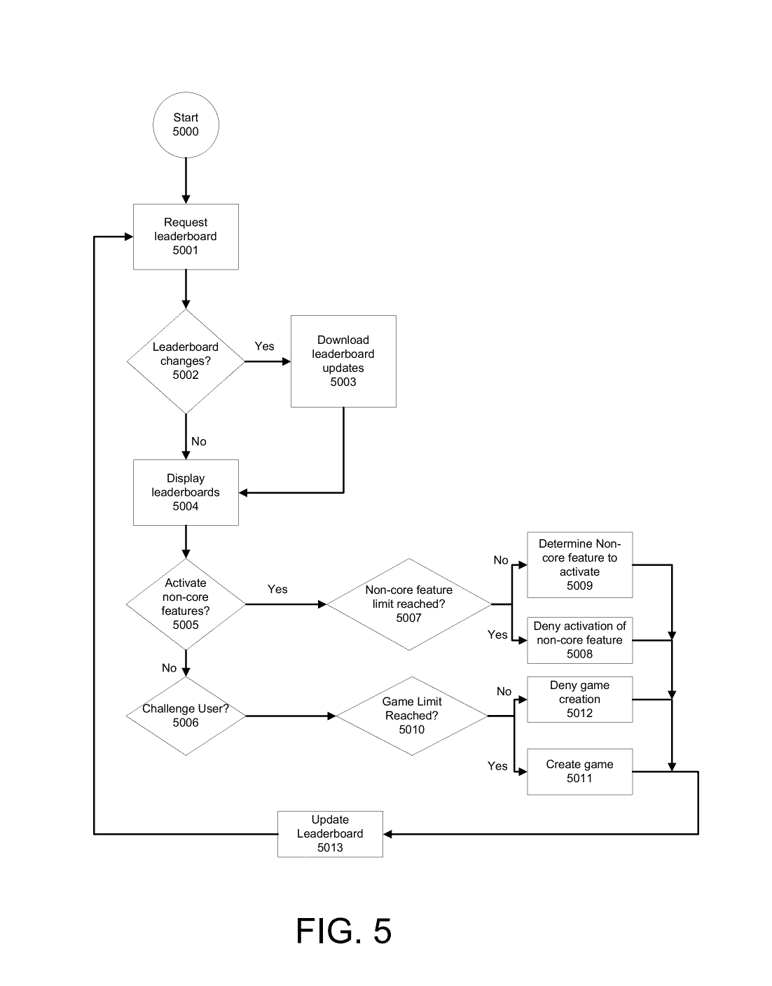

FIG. 5 depicts an example process flow of how a leaderboard and its associated features may be used by a user. At the start, a user chooses the option to view the leaderboards 5000. The user views the leaderboard 5001 and at this time the client determines whether there are changes made to the leaderboard 5002. This may be done by comparing the rankings of the leaderboards, but this may be timeconsuming. Another method may be to have a simple changelog downloaded based on the “version” of the leaderboard a user has or possibly by a timestamp of the leaderboard the current user has. This may be used if leaderboards are only updated intermittently on the server. If there have been changes to the leaderboard, detailed information about the rankings are downloaded from the server 5003. In all the flow processes described, whether functions are processed on client or server are interchangeable. In some instances, processes can occur exclusively on the client or server, and in other instances, processes may occur on a combination of both. The most current leaderboards are then displayed to the user 5004. In certain instances, the most current leaderboard is only obtained for the leaderboard that the user is viewing. For example, the information for the leaderboard for only social network leaderboards are obtained if a user is viewing that tab, and an additional server request may be made when the user clicks on another tab, such as the global tab. In other instances, the information for all leaderboards is obtained as soon as the request for one leaderboard is obtained. The game design has to tradeoff the use of network request to the leaderboard server (which can consume battery life), versus the latency of viewing the leaderboard, if the information is downloaded when the user is actually viewing.

After the rankings/leaderboards have been displayed to a user 5004, the user can choose to activate non-core features 5005, using an attack button, or challenge a user on the leaderboard 5006, using a challenge button. In both instances, there may be a limit on the number of attacks 5007 or the number of challenges or game creations 5010 that may be made against an opponent or ranked user. For example, in some asynchronous, turn-based, PvP title, there may be a limit of the number of active games a user is allowed to have in their queue. Similarly, the system may limit the number of attacks that a user or team may be able to have non-core features activated by external players. This limitation may vary depending on the type of non-core feature activated. For example, in the flight game, if too many memory targeting systems are activated, there may not be a “safe” area of the screen for any plane to be. If the limit is reached for game creation 5010 or non-core feature activation 5007, then the system denies the game creation 5012 or the non-core feature activation 5008, respectively. If the limit is not reached for game creation, then the game is created between the user and the user that is challenged 5011. If a non-core feature is activated, then the system determines the non-core features to activate 5009 in a method similar to that of FIG. 3b. If no other actions are taken by the user in the leaderboard, at some pre-determined or random temporal interval, the leaderboards may be updated 5013. Intervals need not always be temporal, for example, in a leaderboard example, the interval may be based on the number of ranking changes between players. If a leaderboard has 1000 changes in the rankings, then the leaderboards shown to users may automatically be pushed down to the users, regardless of whether they are viewing the leaderboards at that moment.

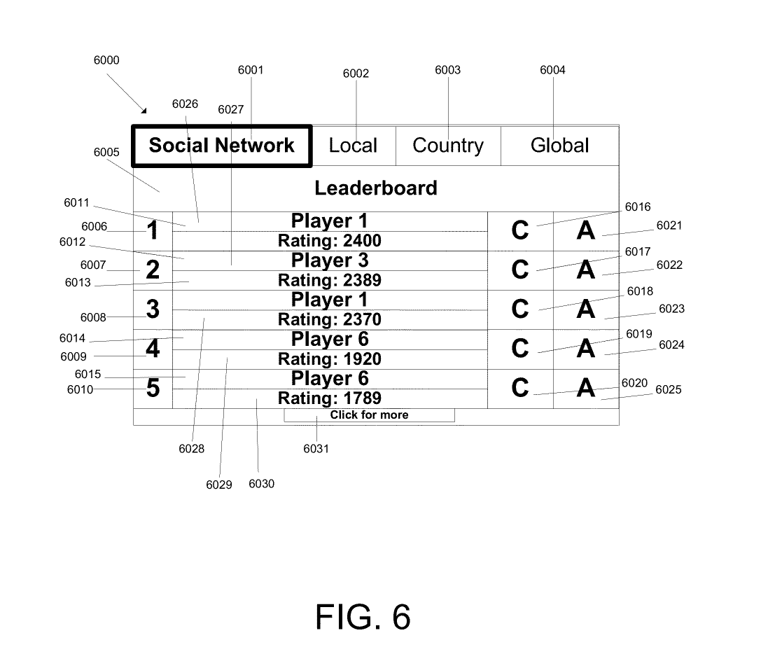

FIG. 6 illustrates an alternative style of leaderboard, where users are ranked by their personal rating rather than metric, such as a score, of the game. The example leaderboard of FIG. 6 has similar features to that of the prior leaderboards. The screen 6000 of the leaderboard displays various tabs, such as a social network leaderboard tab 6001, a local leaderboard tab 6002, a country leaderboard tab 6003, and a global leaderboard tab 6004. There is a menu text 6005, indicating that the user is viewing a leaderboard. In this particular example, only the top five rankings are shown in ranking texts 6006 to 6010, respectively, and the associated players' names to those rankings shown in player texts 6011 to 6015, respectively. Similarly to prior example leaderboards, challenge buttons 6016 to 6020 and attack buttons 6021 to 6025 may be associated to the first five rankings, respectively. The difference in the leaderboards, other than having only a single player texts 6011 to 6015 are the associated ratings of those players shown in ratings texts 6026 to 6030 of the top five rankings, respectively. A user can click on the “click for more” button 6031 to see more rankings.

Having a user rating, rather than a game score rating may be used if the system is encouraging users to play with all types of players. For example, if the only way a user can go up in the rankings is to defeat a higher ranked player, such as in a king-of-the-hill type leaderboard, or to earn a higher score, perhaps a cumulative score, then most lower-ranked players may only challenge higher-ranked players. Or, if ranking is by cumulative score, most lower ranked players may simply challenge many even lower-ranked players to get more games and scores, rather to actually face a more elite player. By basing a leaderboard on skill rating of the player, rather than achievements in a game, users may be more likely to challenge users and accept challenges. For example, generally a much lower ranked player may not want to challenge a much higher-ranked player, but if the lower ranked player were to win and the increase in that player's rating was a function of the difference in the rankings of the players, then this may be a better risk to take, than if the ranking was based purely on something like a win-loss record. Similarly, a higher-ranked player would not simply choose to play against many lower-ranked players because even if they were to win, their rating would not improve much because all the wins were against lower-ranked players. The problem with this system largely occurs when users are “new” to a system, particularly when players move from one system to another. This is the moment when a user can influence their rating the quickest because no baseline rating has been established.

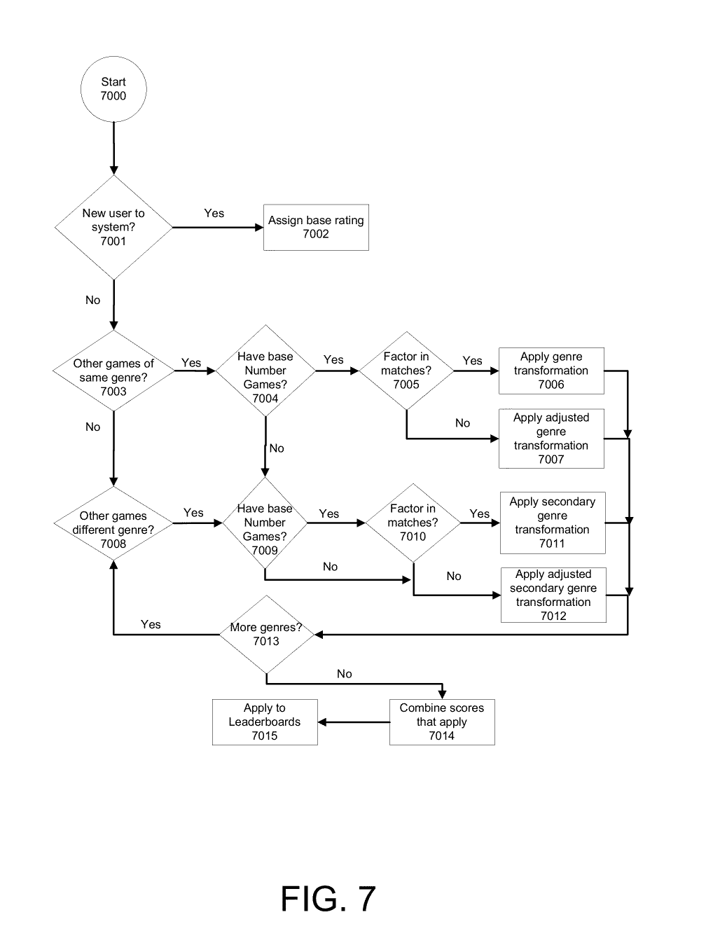

To solve the problem explained above, FIG. 7 illustrates the process flow of a system that accounts for a new entrant into a system to properly create an initial rating of the user. This problem is important because when a user is new to a game, most systems have the users all start at the same rating, usually some type of middle rating, until they can establish the user's true rating across many games and many different types of opponents. In the start 7000 of the application of an adjusted rating for when a new user enters a game, the system determines if the new user is completely new to the system or simply new to the game 7001. If a user is completely new to the system, then a base level rating is applied 7002. However, once a user is in a system with many games, then an adjusted base rating may be applied so that a user need not be inaccurately assigned an incorrect rating.

Every game would be assigned a genre score, some variable that is stored and applied to each game. If a first game were assigned a first genre score, then the system would determine whether there were other games of the same genre 7003 with which to pull over a rating. For example, genres could be compared by the score and comparison of whether a game is in the “same” genre can be a threshold of difference, either a difference, a ratio, or whether there are game genre difference scores. For example, there could be a spectrum of game genres from 1 to 100 where a fast-twitch game like an FPS is assigned a rating of 1 and a strategy game such as chess may be assigned 100. A similar or “same” genre may be defined as any game that is within a range. For example, a fighting game may be a fast-twitch game but does not have the same types of mechanics, nevertheless it may be assigned a score of 9 on the spectrum, and the system may have 10 to be the limit to be considered in the “same” genre. Therefore, all games in which a new user had played that was within the “same” genre 7003 would be considered. There may also be a base number of other games within the same genre 7004 required before a score may be assigned. Finally, the system may also consider if an adequate number of matches 7005 in each game that a user played was enough to apply an adjusted rating. For example, a new user may be entering a new FPS game in the system, and that new user may have played in a few matches in another FPS game in the system but many matches in a fighting game in the system. The system would have to weigh the ratings differently because the fighting game's score likely had a more accurate score for that genre, but the genre was a farther distance among the spectrum than another direct FPS game. If a new user had enough experience within the system, that is, having played many other games 7004 of the same genre 7003 and having played a minimum number of matches in each game 7005, then a genre transformation may be applied. In other words, the new user would have a base level rating adjusted by the genre transformation factor. On the other hand, if any of the information needed to make the information is lacking, then a user may need to apply an adjusted genre transformation 7007 that wouldn't give the user as much of a change from the base level rating, either adjusted upwards or downwards.

For example, if a user did not play in many other games of the same genre, then the system may go through the same process as the “same genre” games but look at different genre games 7008, again determining if a user played many different games of the different genres 7009 and factoring in the number of matches in those games 7010. For example, if a user had not played many FPSs but had played many games of a puzzle blitz game, then they may still have good fast-twitch muscles and good mental faculty to be awarded a higher score. The more information the system has about the user, the higher the variation it may give to the base level rating and apply a secondary genre transformation 7011. However, if there is not enough information about a particular game, a secondary genre transformation score is applied 7012. If more information is needed about the user the system may go farther and farther down the scale of games differing from the new game that a user is entering 7013. Different weighting would have to apply as the system collected information from other games, other genres, and factoring in the amount of matches a user has played per game. When the system has enough information regarding the user 7013, the system combines the score and applies it to the base level rating 7014. If rating is a method of determining rank on a leaderboard, the new user, without having played a game, may appear on the leaderboards according to the adjusted rating 7015.

A game may implement this type of system because in some instance it may be fairer because if a new user should be ranked very highly, then those users who have higher rankings that lose to the new user should not be significantly adversely affected by that new user's initial low ranking. It may also be better for a new user, because in some games that have a random game creation matching system based on ratings, a highly skilled user may not want to play with many poorly rated players when he is actually highly skilled.

Several example embodiments of the present invention are specifically illustrated and described herein. The advantages and features of the application are of a representative sample of embodiments only, and are not exhaustive and/or exclusive. They are presented only to assist in understanding and teaching the claimed principles. It should be understood that they are not representative of all claimed inventions. Moreover, they are not to be limited to the technologies or devices described herein. That an alternate embodiment may not have been presented is not a disclaimer of such alternate embodiment. It will be appreciated and understood that other embodiments may be utilized and functional, logical, organizational, structural and/or topological modifications may be made without departing from the scope and/or sprit of the embodiments discussed herein relative to those not discussed herein other than it is for purposes of non-repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others.

In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims. It is to be understood that, depending on the particular needs and/or characteristics of an individual, entity, and/or enterprise user, database configuration and/or relational model, data type, data transmission and/or network framework, syntax structure, and/or the like, various embodiments of the invention, may be implemented that enable a great deal of flexibility and customization. For example, aspects of the invention may be adapted for non-game use. While various embodiments and discussions of the invention have been directed to examples in virtual games, however, it is to be understood that the embodiments described herein may be readily configured and/or customized for a wide variety of other applications and/or implementations.

1. A method for activating non-core features in an asynchronous game, comprising:
receiving a request to activate a non-core feature from a first user on a first turn of a turn-based game, wherein the input to activate the non-core feature is made on one or more computing devices;
storing the activation of the non-core feature; and
sending the request to activate the non-core feature to a second user on a second turn of the turn-based game, wherein the second user is participating in the closed game environment corresponding to a computer-implemented game.

2. The method for activating non-core features in an asynchronous game, according to claim 1, further comprising:
receiving, by one or more computing devices, a first turn of the turn-based game for a closed game environment corresponding to a computer-implemented game from the first user;
storing the first turn from the first user in a storage device; and
sending the first turn for the turn-based closed game to the second user, wherein the sending of the first turn triggers a flag to allow a second user to take the second turn.

3. The method for activating non-core features in an asynchronous game, according to claim 1, wherein the non-core feature is activated specifically for the second turn of the turn-based game by the second user.

4. The method for activating non-core features in an asynchronous game, according to claim 1, further comprising activating the non-core feature using stored data.

5. The method for activating non-core features in an asynchronous game, according to claim 4, wherein the data is related to information specific to the second user.

6. The method for activating non-core features in an asynchronous game, according to claim 4, wherein the data is related to data among a subset of all users in the turn-based game.

7. The method for activating non-core features in an asynchronous game, according to claim 1, further comprising sending data to the second user to implement the non-core feature activation, wherein the second user is one of a real person or a computer artificial intelligence.

8. The method for activating non-core features in an asynchronous game, according to claim 1, wherein the non-core feature is customizable by the first user before activation.

9. The method for activating non-core features in an asynchronous game, according to claim 2, wherein the first turn to the second user and the non-core feature are encapsulated in a turn object that defines a sequence of events graphically illustrated on a computing device of the second user.

10. The method for activating non-core features in an asynchronous game, according to claim 1, wherein the activation of the non-core feature is tied to the use of a virtual currency.

11. The method for activating non-core features in an asynchronous game, according to claim 1, wherein the activation of the non-core feature is tied to a bank of accumulated non-core features.

12. The method for activating non-core features in an asynchronous game, according to claim 1, wherein the activation of the non-core feature is by a third user that is not a participant in the turn-based, closed game environment corresponding to a computer-implemented game.

13. The method for activating non-core features in an asynchronous game, according to claim 12, wherein the third user activates the non-core feature from a leaderboard of the turn-based game.

14. The method for activating non-core features in an asynchronous game, according to claim 1, further comprising storing the results of the turn-based, closed game on a leaderboard.

15. The method for activating non-core features in an asynchronous game, according to claim 2, further comprising receiving a turn from the second user, wherein the turn contains the results affected by the first user's activation of the non-core feature.

16. The method for activating non-core features in an asynchronous game, according to claim 15, further comprising receiving a request to activate a non-core feature from the second user to be activated in the next turn of the first user.

17. An apparatus, comprising: one or more processors; and a memory coupled to the processors comprising instructions executable by the processors, the processors operable when executing the instructions to:
receive a request to activate a non-core feature from a first user on a first turn of a turn-based game, wherein the input to activate the non-core feature is made on one or more computing devices;
store the activation of the non-core feature; and
send the request to activate the non-core feature to a second user on a second turn of the turn-based game, wherein the second user is participating in the closed game environment corresponding to a computer-implemented game.

18. The apparatus of claim 17, further comprising executing instructions to:
receive a first turn for a asynchronous, turn-based, closed game environment corresponding to a computer-implemented game from the first user;
store the first turn from the first user in a storage device; and
send the first turn for the asynchronous, turn-based, closed game to the second user.

19. A non-transitory, computer readable medium comprising instructions operative, when executed, to cause one or more processors to:
receive a request to activate a non-core feature from a first user on a first turn of a turn-based game, wherein the input to activate the non-core feature is made on one or more computing devices;
store the activation of the non-core feature; and
send the request to activate the non-core feature to a second user on a second turn of the turn-based game, wherein the second user is participating in the closed game environment corresponding to a computer-implemented game.

20. The non-transitory, computer readable medium of claim 19, comprising instructions operative, when executed, to cause one or more processors to:
receive a first turn for a asynchronous, turn-based, closed game environment corresponding to a computer-implemented game from the first user;
store the first turn from the first user in a storage device; and
send the first turn for the asynchronous, turn-based, closed game to the second user.
